(19) United States
(12) Patent Application Publication
(10) Pub. No.: US 2026/0213699 A1
(43) Pub. Date: Jul. 23, 2026

(54) NATUREMOUNT SOLAR ARRAYS

(71) Applicant: 1st Avenue Nova, LLC, Los Angeles, CA (US)

(72) Inventor: Thomas BUTTGENBACH, Santa Monica, CA (US)

(73) Assignee: 1st Avenue Nova, LLC, Los Angeles, CA (US)

(21) Appl. No.: 19/420,125

(22) Filed: Dec. 15, 2025

Related U.S. Application Data
(60) Provisional application No. 63/733,972, filed on Dec. 13, 2024.

(51) Int. Cl. H02S 20/32; H02S 40/32

(52) U.S. Cl. CPC H02S 20/32; H02S 40/32

(57) ABSTRACT

An apparatus includes first and second sets of solar panels, and an interface that rotatably couples the solar panels such that (1) an edge is defined therebetween, and (2) an angle therebetween is adjustable. The interface includes hinges at each endpoint. The solar panels and interface form a solar module configured to be disposed on an uneven surface by virtue of at least one of: (i) the solar module not including a coupler at the midpoint of the edge so that the solar panels can be positioned such that their sides are nonparallel, (ii) the second set of solar panels further being rotatable, independently of the first set of solar panels, about a rotational axis different from an axis defined by the edge, or (iii) a deformation in a frame of one of the solar panels.

### CROSS REFERENCE TO RELATED APPLICATION

This application claims priority to U.S. Provisional Patent Application No. 63/733,972, filed Dec. 13, 2024 and titled “EARTHMOUNT SOLAR ARRAYS,” the contents of which are incorporated by reference herein in their entirety.

### TECHNICAL FIELD

The present disclosure relates generally to earth-mountable solar arrays, and more specifically to configurations such as clamshell solar module clusters, table solar module clusters, and centipede solar arrays.

### BACKGROUND

Some known solar arrays are often built by mounting solar modules onto mounting structures, typically either a fixed tilt rack that holds the modules in a fixed orientation or a tracker system that changes the orientation of the modules as the sun moves across the sky.

Fixed tilt racks are often built with a rigid structure and are often mounted on a level surface to ensure the solar modules will be held in the correct orientation. Since naturally occurring land surfaces are generally neither level (from end to end) nor flat (over short distances), the ground surface often must first be leveled and flattened—a process known as grading. Grading is often costly and typically disrupts the local topography such that the land cannot later be returned to its previous form. Grading also often disrupts the natural environment and ecological status of the site. Consequently, a need exists for solar arrays that can accommodate ungraded or naturally graded surfaces of the land.

### SUMMARY

In some embodiments, an apparatus includes a first set of solar panels, a second set of solar panels, and an interface. The interface rotatably couples the first set of solar panels to the second set of solar panels such that (1) an edge is defined between the first set of solar panels and the second set of solar panels, and (2) an angular position of the first set of solar panels relative to the second set of solar panels is adjustable. The interface includes a first hinge at a first endpoint portion of the edge and a second hinge at a second endpoint portion of the edge that is opposite the first endpoint portion of the edge. The apparatus does not include a coupler at a midpoint portion of the edge. The first set of solar panels, the second set of solar panels, and the interface collectively define a solar module configured to be disposed on an uneven surface, such as ungraded or naturally graded land/earth.

In some embodiments, a system includes an alternating current (AC) bus and a plurality of solar module trays. Each solar module tray from the plurality of solar module trays is configured to be electrically coupled to the AC bus. A first solar module tray from the plurality of solar module trays at least one of: (i) includes a first hinge positioned proximal to a first apex of the first solar module tray, and a second hinge positioned at a second apex of the first solar module tray, no hinge being positioned at a midpoint portion between the first apex of the first solar module tray and the second apex of the first solar module tray, (ii) includes an elongate member mechanically attached to each of an edge portion of a first solar module of the first solar module tray and an edge portion of a second solar module of the first solar module tray, (iii) is mechanically coupled to a base having one of a substantially circular cross-sectional shape or a substantially rectangular cross-sectional shape, or (iv) is mechanically coupled to a foam-containing support, such that the first solar module tray can be positioned on a first ungraded or naturally graded surface of land. A second solar module tray from the plurality of solar module trays at least one of: (i) includes a first hinge positioned proximal to a first apex of the first solar module tray, and a second hinge positioned at a second apex of the second solar module tray, no hinge being positioned at a midpoint portion between the first apex of the second solar module tray and the second apex of the second solar module tray, (ii) includes an elongate member mechanically attached to each of an edge portion of a first solar module of the second solar module tray and an edge portion of a second solar module of the first solar module tray, (iii) is mechanically coupled to a base having one of a substantially circular cross-sectional shape or a substantially rectangular cross-sectional shape, or (iv) is mechanically coupled to a foam-containing support, such that the second solar module tray can be positioned on a second ungraded surface or naturally graded of land different from the first ungraded or naturally graded surface of land.

In some embodiments, a system includes a first solar module, a second solar module, and at least one hinge. The first solar module includes a first set of solar panels, a first frame mechanically coupled to the first set of solar panels, and a first set of electronic circuits that is (1) electrically coupled to the first set of solar panels and (2) mechanically coupled to the first frame. The second solar module includes a second set of solar panels, a second frame mechanically coupled to the second set of solar panels, and a second set of electronic circuits that is (a) electrically coupled to the second set of solar panels and (b) mechanically coupled to the second frame. The at least one hinge rotatably couples the first frame to the second frame. The apparatus is configurable between an open position in which the first solar module and the second solar module form a nonzero angle therebetween, and a closed position in which substantially no angle is formed (or a substantially “zero angle” is formed) between the first solar module and the second solar module. The apparatus does not include a coupler at a midpoint portion of an edge formed between the first solar module and the second solar module.

### BRIEF DESCRIPTION OF THE DRAWINGS

FIG. 1 depicts a perspective view of an example solar module cluster in a clamshell configuration, according to an embodiment.

FIG. 2 depicts a perspective view of an example solar module cluster with hinges, according to an embodiment.

FIG. 3 depicts a perspective view of an example solar module cluster configurable to move between an open-book position and a closed-book position, according to an embodiment.

FIG. 4 depicts a perspective view of an example solar module with a frame depth behind a solar panel, according to an embodiment.

FIG. 5 depicts a perspective view of an example solar module cluster with included space behind solar panels, according to an embodiment.

FIG. 6 depicts a perspective view of an example solar module cluster configurable to move between an open-book position and a closed-book position, according to another embodiment.

FIG. 7 depicts a perspective view of an example centipede array configurable to be deployed on uneven ground, according to an embodiment.

FIG. 8 depicts a perspective view of an example solar module cluster that is joined and hinged to have relative rigidity, according to an embodiment.

FIG. 9 depicts a perspective view of an example solar module cluster that is joined and hinged to have relative flexibility, according to an embodiment.

FIG. 10 depicts a perspective view of an example solar module cluster with a type of cross-tray member, according to an embodiment.

FIG. 11 depicts a perspective view of an example solar module cluster with another type of cross-tray member, according to an embodiment.

FIG. 12 depicts a perspective view of a system for supporting a solar module cluster, according to an embodiment.

FIG. 13 depicts a perspective view of another system for supporting a solar module cluster, according to an embodiment.

FIG. 14 depicts a perspective view of yet another system for supporting a solar module cluster, according to an embodiment.

FIG. 15 shows a cross-section of a system for anchoring a clamshell solar module cluster, in accordance with some embodiments.

FIG. 16 shows a partial cross-section of an example fastener assembly, according to an embodiment.

FIG. 17 is a wiring diagram for a 2×2 solar module cluster, according to an embodiment.

FIG. 18 depicts a perspective view of an example solar module cluster with a type of DC wiring, according to an embodiment.

FIG. 19 depicts a perspective view of a system for electrically coupling two or more solar module clusters, according to an embodiment.

FIG. 20 depicts a perspective view of an example table solar module cluster, according to an embodiment.

### DETAILED DESCRIPTION

As used herein, a solar module cluster (also referred to herein as a solar tray or a solar module tray) can refer to a an array of solar panels or solar modules. A solar module cluster may be pre-assembled and pre-wired in a factory prior to delivery and installation (rather than being assembled from separate solar modules in the field during installation). Alternatively or in addition, a solar module cluster may include a frame(s) or be coupled to a frame(s), and can include, by way of example, anywhere from 2-8 modules.

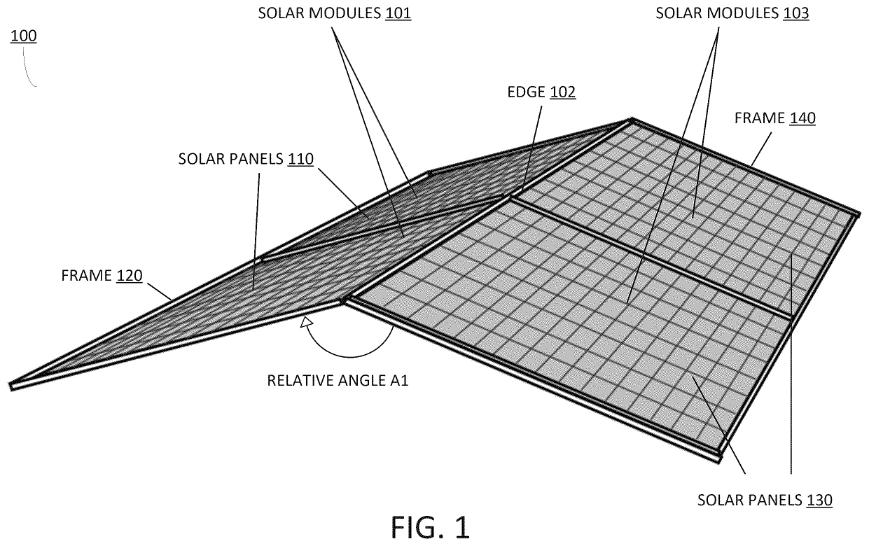

In some embodiments of the present disclosure, an arrangement/configuration for a solar tray is described. For example, a 4-module solar tray is depicted and described with respect to at least FIG. 1, and the 4-module arrangement/configuration can be extended (or modified) to any even number of modules (e.g., 2 modules, 6 modules, 8 modules, etc.). In some embodiments of the present disclosure, a solar tray can have an arrangement/configuration that is described as a clamshell (or inverted “V”). A clamshell solar module cluster (also referred to herein as a “clamshell module cluster” or “clamshell array”) can be and/or include a hinged solar tray that facilitates the rapid deployment of a solar array into an inverted-V configuration. A clamshell solar module cluster can be mounted on a suitable mounting structure or, with appropriate provision to hold/position the solar tray with a specified angle, can be placed directly on the ground or on a type of supporting (e.g. horizontal) surface while maintaining the specified angle.

In some implementations of the clamshell solar module cluster described herein, one or more microinverters and/or power optimizers can be mounted onto the module frame and/or attached to the back of the solar panel itself (e.g., the non-active side of the solar panel), optionally together with an associated housing(s) and/or other electronics.

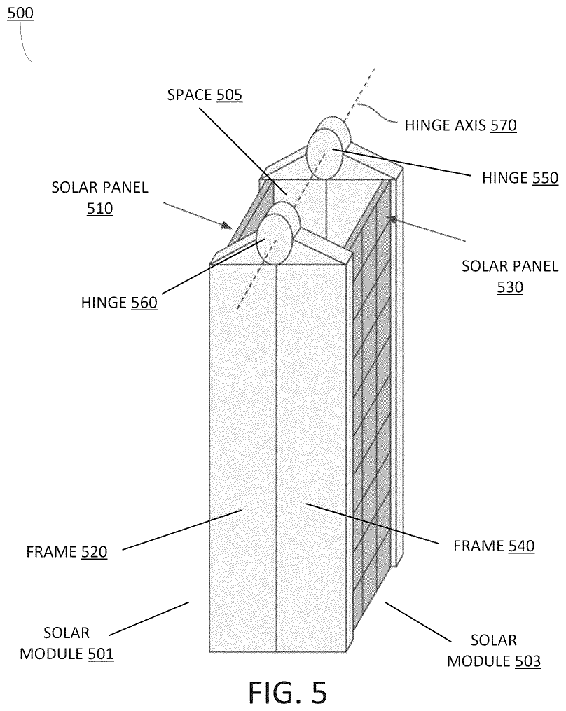

When the clamshell solar module cluster is in the closed-book position, the microinverters or power optimizers can be positioned in the space between the backs (e.g., the inactive sides) of the solar panels, where they can be protected, for example when the tray is being moved (e.g., moved into and out of a container for transportation, being moved around a field where the solar system will be deployed, etc.). An example “space-enclosing” solar module cluster is described and shown in FIG. 5.

In some such implementations, the microinverters and/or power optimizers can be mounted close to (or can be collocated with) the hinge line/apex line of the clamshell solar module cluster. Collocating the microinverters and/or power optimizers with the hinge line of the clamshell solar module cluster can ensure that, in situations where the clamshell solar module cluster is mounted on or close to the ground, the electrical wiring and power conversion system (PCS) devices are kept far above any standing water, e.g., in case of rain or flooding.

With the microinverters or power optimizers already mounted on (and protected by) the clamshell solar module cluster, they can also be wired to their solar modules. Such wiring can be done in a factory rather than in the field and accordingly is referred to herein as pre-installed wiring. Pre-installed wiring can facilitate deployment of solar module cluster(s) by reducing labor to be performed in the field. Pre-installed wiring can also increase system reliability because wiring of the microinverters or power optimizers to the solar modules can be done in controlled, repeatable conditions by people who specialize in the task and who may have specialized tooling available to them.

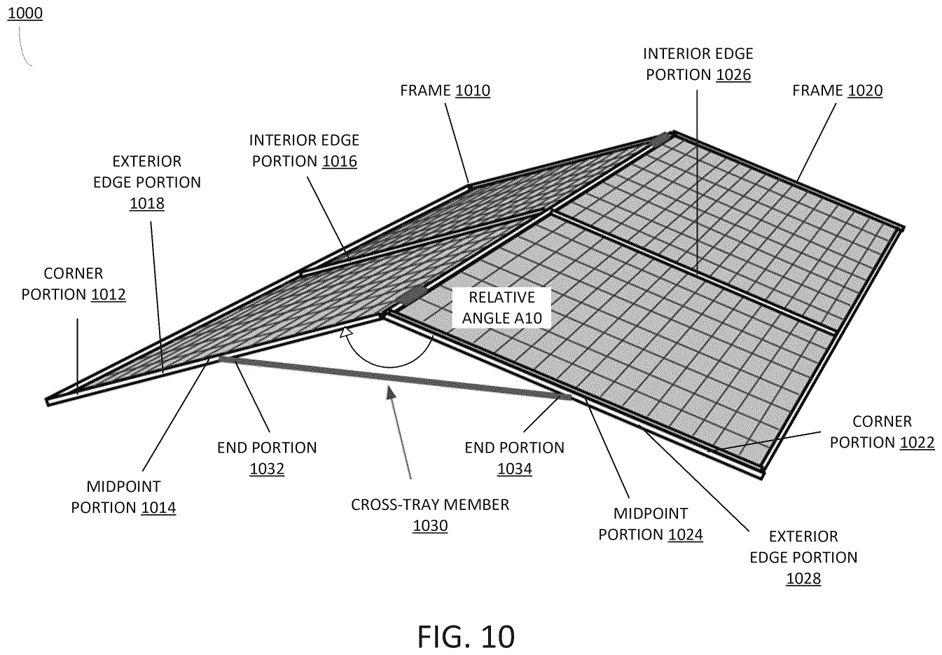

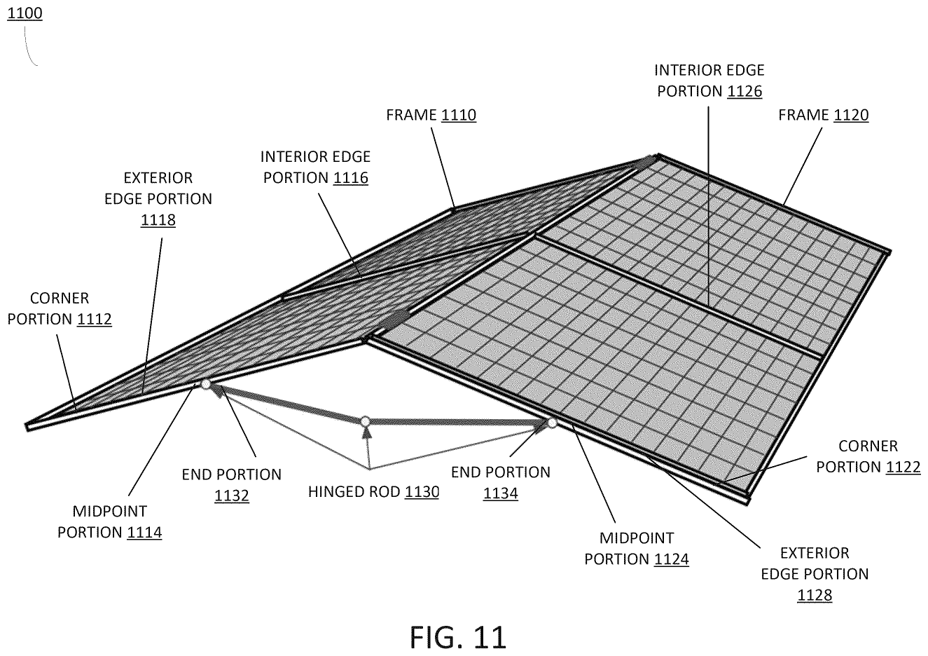

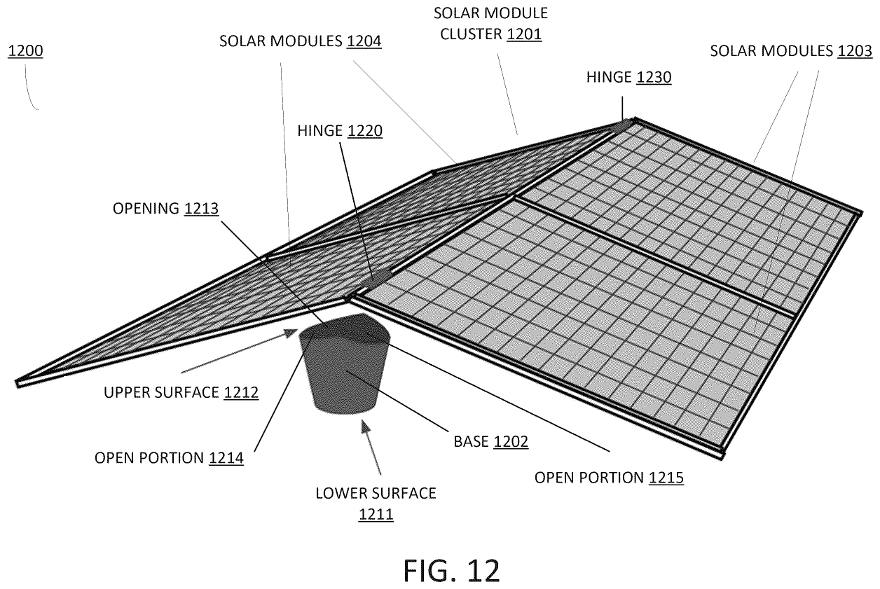

In some embodiments, since the clamshell solar module cluster is hinged, it can be desirable to have some means of fixing the angle of the hinges when the solar module cluster is deployed. One example method of fixing the angle includes using a cross-tray member (also referred to herein as a connector or an elongate member) to limit the relative angle of the solar module cluster and/or the angular position of a first solar module relative to a second solar module (e.g., to a factory-determined and thus “predefined” value). Example cross-tray members are described and shown in FIGS. 10-11. Another example method of fixing the angle includes using a support mechanism (also referred to herein as a support or a base) to set the height of the apex line/edge of the solar module cluster. Example support mechanisms are described and shown in FIGS. 12-14.

In some embodiments, the clamshell solar module cluster can be hinged and a component(s) (e.g., cross-tray member(s), support mechanism(s), etc.) can be included that is configured to fix the angle of the hinges when the clamshell solar module cluster is deployed. Fixing the angle can be achieved, for example, by supporting the solar module cluster from below. In a first such example, the clamshell solar module cluster can be supported from below by one or more vertically oriented (e.g., ground-mounted) posts, and rest/position the apex of the tray on said posts (optionally fixed thereto, for example, using clamps located on the tops and/or sides of the posts). One practical issue that can arise is that the ground underneath a solar module cluster may be soft, either permanently or periodically (e.g., as a result of rain or flooding). A smaller-diameter post might sink into the soft ground under the weight of the solar module cluster. Posts with larger footprints/volumes, however, can take up an undesirably high amount of space during transportation to the site and/or at the site.

To address the foregoing issues, one or more supports can be constructed in the form of a truncated inverted cone (or other embodiments as described herein)—inverted meaning that portion of the truncated inverted cone that would have included the point of a cone is understood to be facing downward (e.g., disposed on the ground), and truncated meaning that the cones do not go all the way to a point but instead terminate in a flat surface. The cones can be closed at this flat lower surface, e.g., to facilitate distribution of the load across an area of the ground, while the upper surface of each cone can in some implementations be open, allowing the cones to be stacked one inside another for transportation. An example truncated inverted cone is shown and described in FIG. 12.

Instead of deploying solar module clusters in a fixed orientation, on racks that have fixed geometry and require graded land, and in accordance with some embodiments, one can instead deploy the solar module clusters while leaving the natural topography undisturbed or largely undisturbed. One approach to this is to implement what is referred to herein as a centipede array. The centipede array includes a plurality of solar module clusters, each solar module cluster configured to be mounted on a natural (or ungraded) surface of the land. Because of the varying slope of the land, the centipede array will have solar modules that are not all in the same fixed orientation but instead have varying orientations. If the solar modules are to be mounted with a fixed orientation, the solar module clusters can have adjustable geometry. For example, a manner in which the solar module clusters are supported above the ground can be adjusted, e.g., by adjusting the height each support point is set to in the ground screw mounting implementation discussed below.

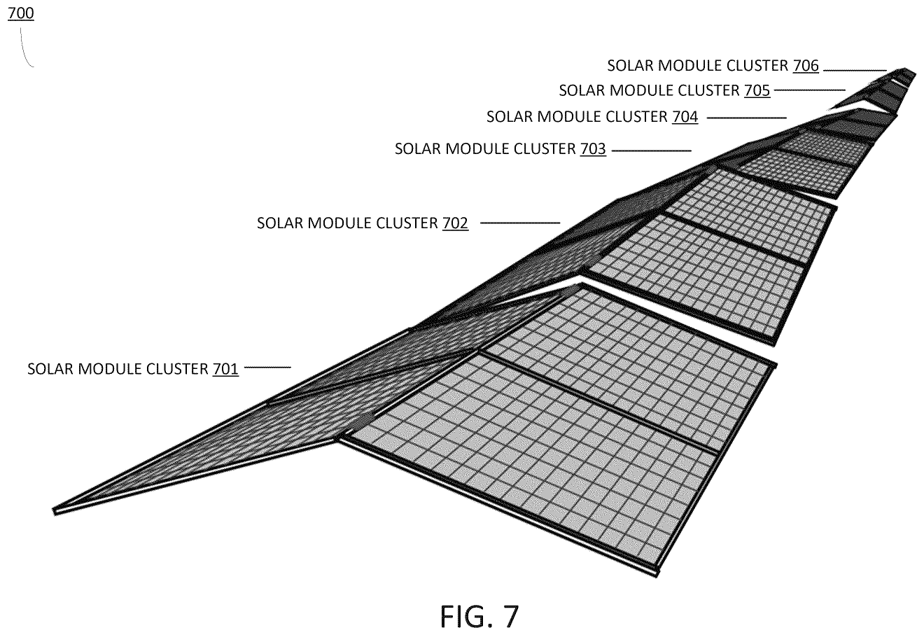

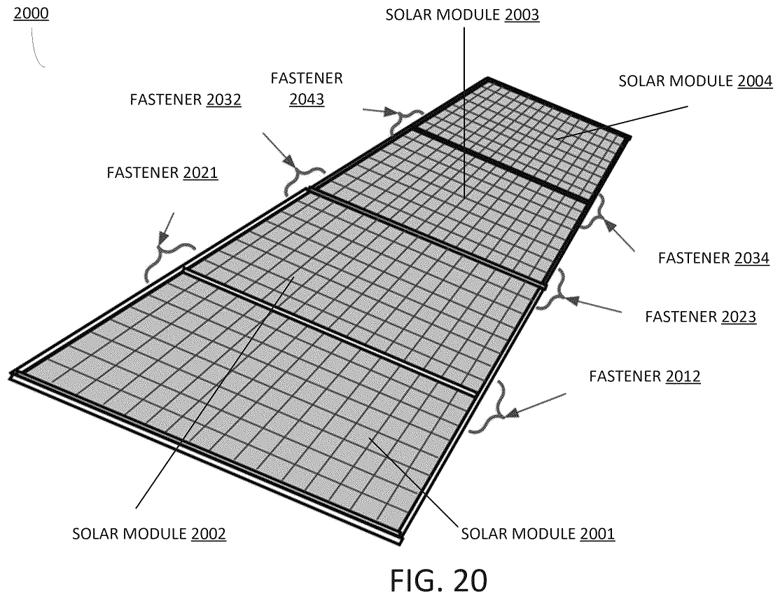

In some implementations of the centipede array, the use of relatively shorter (e.g., 4 modules in a 2×2 clamshell arrangement or in a 4×1 linear “table” arrangement, as discussed below with respect to at least FIG. 20) solar module clusters (analogous to segments of a centipede) helps the overall centipede array to follow the natural topography because the solar modules can be tilted or rotated relative to each other. Such a configuration allows for installation of a long row of solar modules that can follow/conform to slopes, valleys and peaks. Such a configuration also allows portions of the centipede array to “roll” from side to side, again following the natural contours of the terrain/land. An example centipede array is described and shown in FIG. 7.

The clamshell solar module cluster, when deployed, and in accordance with some embodiments, can have a natural axis along the hinge line (or, equivalently, along the apex). If the hinge line is aligned generally north-south, then during the morning, the modules to the east of the hinge line will tend to produce more power; and during the afternoon, the modules to the west of the hinge line will tend to produce more power. On the other hand, if the hinge line is aligned generally east-west, in the northern hemisphere the solar modules on the south side of the hinge line will tend to produce more power, with their advantage being greatest in the middle of the day and less in the early morning and late evening. In either case, and in some implementations, first strings of solar modules can be made of solar modules on the same side of the hinge line, and second strings of solar modules can be made of solar modules on the same opposite side of the hinge line, the first strings having microinverters and/or power optimizers different from microinverters or power optimizers of the second strings. In addition, electrical wiring can be installed and generally kept close to (e.g., collocated with) the hinge line, to protect the electrical wiring from standing water during rain or flooding, in those situations where the clamshell solar module cluster is mounted on or close to the ground.

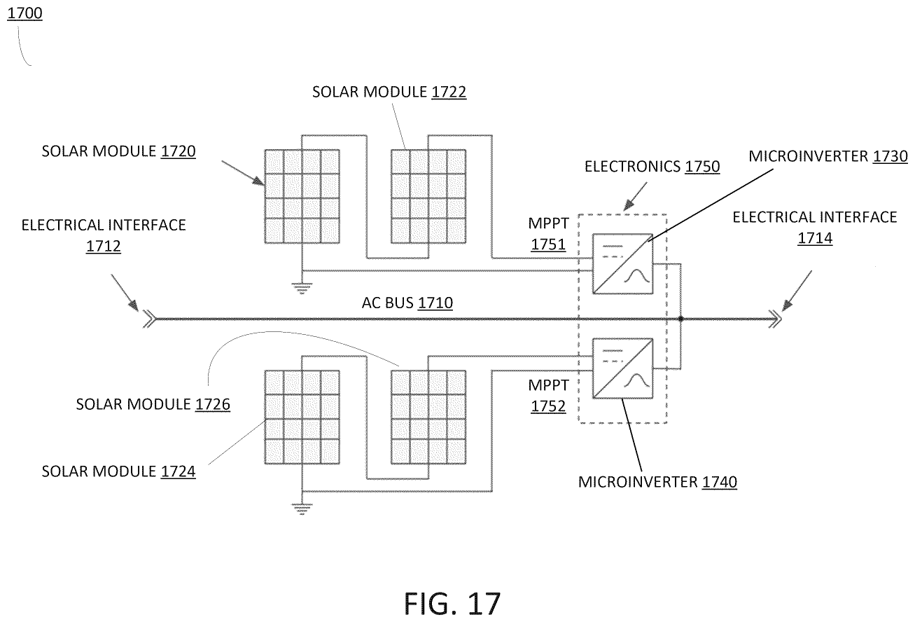

For example, a first solar module cluster can be oriented relative to a second solar modular cluster such that a hinge line of the first solar module cluster substantially aligns with a hinge line of the second solar module cluster, to define a “common” hinge line among both the first solar module cluster and the second solar module cluster. As used herein, a substantial alignment can refer to an alignment between two components that is less than perfect (e.g., a hinge axis of one solar module cluster has a 0.25° angle, or a 0.5° angle, or a 1° angle, or a 2° angle relative to a hinge axis of another solar module cluster). The “common” hinge line can be disposed between a first set of solar modules and a second set of solar modules, for each of the first solar module cluster and the second solar module cluster. Collectively, the first set of solar modules can define a first solar module string, and the second set of solar modules can define a second solar module string that is different from the first solar module string. Solar module(s) of the first solar module string (e.g., that are on one side of the “common” hinge line) can be electrically coupled together and solar module(s) of the second solar module string (e.g., that are on an opposite side of the “common” hinge line with respect to the first solar module string) can be electrically coupled together, without an electrical coupling between solar module(s) of the first solar module string and solar module(s) of the second solar module string. Example wiring configurations for solar module cluster(s) are described and shown in FIGS. 17-19.

Some microinverters (or power optimizers) can be configured to connect to only a single solar module. Some microinverters (or power optimizers) can be configured to connect to a small number of solar modules (e.g., 2, 3, 4, 5, or 6 solar modules), power optimizing the operation of that small number of solar modules as a group (i.e., as a small string). Still other microinverters can be configured to connect to more than one small string. In some implementations, solar modules that define a first solar module string can be electrically coupled to a first set of electronics (e.g., microinverters, power optimizers, etc.) and solar modules that define a second solar module string can be electrically coupled to a second set of electronics separate and different from the first set of electronics.

In some embodiments, a table solar module cluster can be implemented as one side of a clamshell solar module cluster. A table solar module cluster can include a set of solar modules coupled (e.g., affixed, etc.) to each other in a row or linear array, for example using fasteners as described herein. An example table solar module cluster is described and shown in FIG. 20.

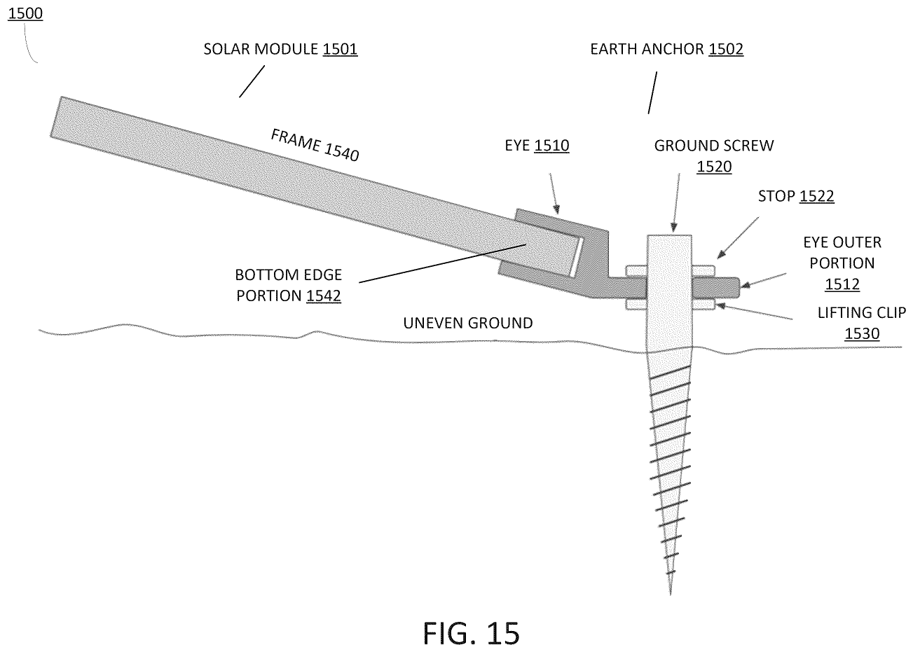

In some such implementations, the table solar module cluster can be anchored to the ground (e.g., to the earth, to a concrete slab, etc.) using a ground screw mechanism such as that described herein (see, for example, FIG. 15). For example, the table solar module cluster can be anchored such that each solar module in the table solar module cluster can be disposed at a specified distance and along a plane(s) that is substantially parallel to a surface of the earth, using the ground screw type arrangement in FIG. 15. As used herein, a solar module (or other component) that is “substantially” parallel to the earth's surface is understood to account for variations (or imperfections) along the earth's surface that prevent the surface from defining a straight line or flat plane. In other words, a solar module (or other component) that is “substantially” parallel to the earth's surface can be substantially parallel to (e.g., being 0.25° angled, 0.5° angled, 1° angled, or 2° angled relative to) a hypothetical line or plane that defines an average elevation among the relevant portions of the earth's surface.

In some such implementations, table solar module clusters can be used to construct “tent” or “inverted V” arrays, which can be similar in layout to the open-book clamshell solar module cluster but without the hinge feature(s). Such configurations can be implemented, for example, by mounting a pair of table solar module clusters side by side and attaching the table solar module clusters to each other using one or more clamps and/or clips that accommodate (and, optionally, define) the angle of the tent apex. The angle of the “tent” can be maintained using one or more cross-array members, stackable inverted cones (e.g., having a circular cross-section or a rectangular cross-section), terrain-following foam supports, etc. In some such implementations, one or more additional structural features can be included, in addition to the clamps and/or clips along the apex, to maintain the enclosed angle, for example since the solar module frames may not themselves be strong enough to support a large bending moment(s).

FIG. 1 depicts an example solar module cluster 100 in a clamshell configuration, according to an embodiment. Solar module cluster 100 can be configured to be disposed on an uneven surface. For example, solar module cluster 100 can be disposed on an ungraded or naturally graded surface of the land. Solar module cluster 100 is configurable between an open position (or open configuration) (shown in FIG. 1) and a closed position (or closed configuration) (not shown in FIG. 1). Solar module cluster 100 includes solar modules 101 and solar modules 103. Solar modules 101 can be coupled to solar modules 103 such that relative angle A1 is formed between solar modules 101 and solar modules 103, and edge 102 is defined between solar modules 101 and solar modules 103. Solar modules 101 includes solar panels 110 and frame 120. Solar panels 110 can be mechanically coupled to frame 120. Solar modules 103 includes solar panels 130 and frame 140. Solar panels 130 can be mechanically coupled to frame 140.

In some implementations, solar module cluster 100 can include an interface (not shown in FIG. 1) that rotatably couples solar modules 101 and solar modules 103 such that an angular position of solar modules 101 relative to an angular position of solar modules 103 is adjustable. For example, solar module cluster 100 can include one or more hinges (not shown in FIG. 1). The hinges can, for example, rotatably couple one or more portions of frame 120 to one or more portions of frame 140. In some implementations, the interface can enable different configurations for solar module cluster 100. For example, solar module cluster 100 is depicted as being in an open configuration such that relative angle A1 is a nonzero angle. When solar module cluster 100 is in the open configuration, solar module cluster 100 can be referred to as being in an “open book” configuration. In some implementations, solar module cluster 100 can be in a closed configuration such that relative angle A1 is a zero angle (or has no angle or an absence of an angle). When solar module cluster 100 is in the closed configuration, solar module cluster 100 can be referred to as being in a “closed book” configuration. Although depicted as including two solar modules (each having a different solar panel), solar module cluster 100 can have, in some embodiments, any even number of solar modules.

In some implementations, solar module cluster 100 can include a single apex with one or more hinges. In some embodiments, however, a solar modular cluster can include more than one apex. An apex of solar module cluster 100 can refer to a portion of solar module cluster 100 that is highest above a surface that solar module cluster 100 is configured to be disposed on. In some implementations, solar module cluster 100 may not include any flexible connectors (e.g., cable(s) or rope(s)) and/or may not include a spring or spring arrangement. Alternatively or in addition, solar module cluster 100 may be freely rotatable/foldable/movable between a closed book configuration and an open book configuration, without any coupling component thereof becoming substantially tensioned (e.g., having a tension value that is 92%, 95%, 98%, 99% of a rated (or maximum) tension value specified for the coupling component) or without a meaningful change to a tension of a coupling component(s) thereof.

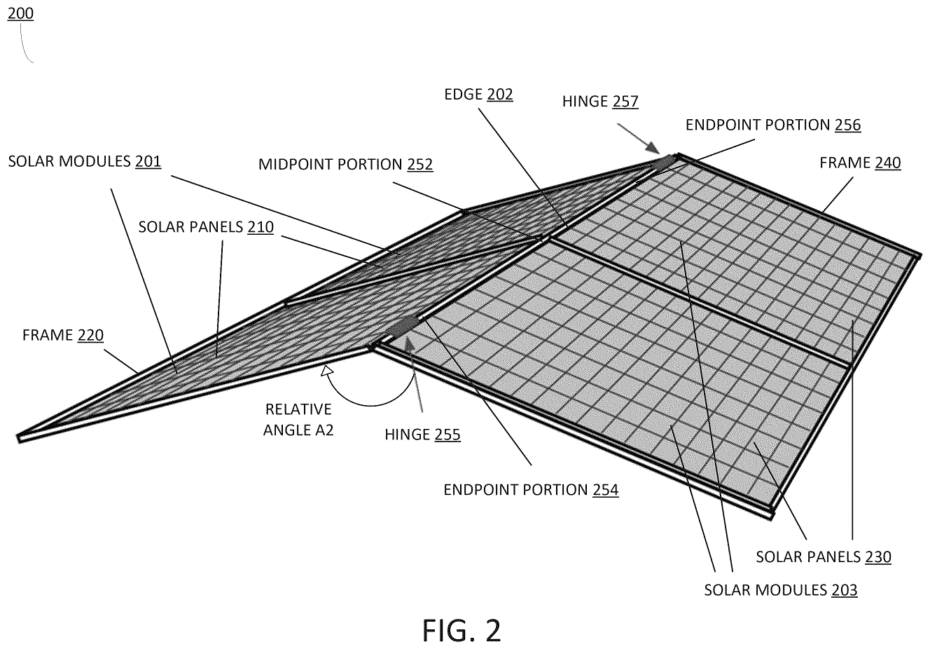

FIG. 2 depicts an example solar module cluster 200 with hinges, according to an embodiment. Solar module cluster 200 includes solar modules 201 (e.g., structurally and/or functionally similar to solar modules 101 of FIG. 1), solar modules 203 (e.g., structurally and/or functionally similar to solar modules 101 of FIG. 1), hinge 255, and hinge 257. Solar modules 201 includes solar panels 210 (e.g., structurally and/or functionally similar to solar panels 110 of FIG. 1) and frame 220 (e.g., structurally and/or functionally similar to frame 120 of FIG. 1). Solar modules 203 includes solar panels 230 (e.g., structurally and/or functionally similar to solar panels 130 of FIG. 1) and frame 240 (e.g., structurally and/or functionally similar to frame 140 of FIG. 1).

Hinge 255 and hinge 257 can each rotatably couple solar modules 201 to solar modules 203 such that relative angle A2 is formed between solar modules 201 and solar modules 203, such that edge 202 is defined between solar modules 101 and solar modules 103, and/or such that solar module cluster 200 is configurable to move between an open book configuration (shown in FIG. 2) and a closed book configuration (not shown in FIG. 2), without disassembling the solar module cluster 200. As depicted, hinge 255 can be disposed at endpoint portion 254 of edge 202 and hinge 257 can be disposed at endpoint portion 256 of edge 202. As depicted, solar module cluster 200 has an absence of a coupler (e.g., a hinge, etc.) at midpoint portion 252 of edge 202. Although depicted as having a single hinge at endpoint portion 254 and a single hinge at endpoint portion 256, in some embodiments, solar module cluster 200 can have more than one hinge at an endpoint portion (or at both endpoint portions).

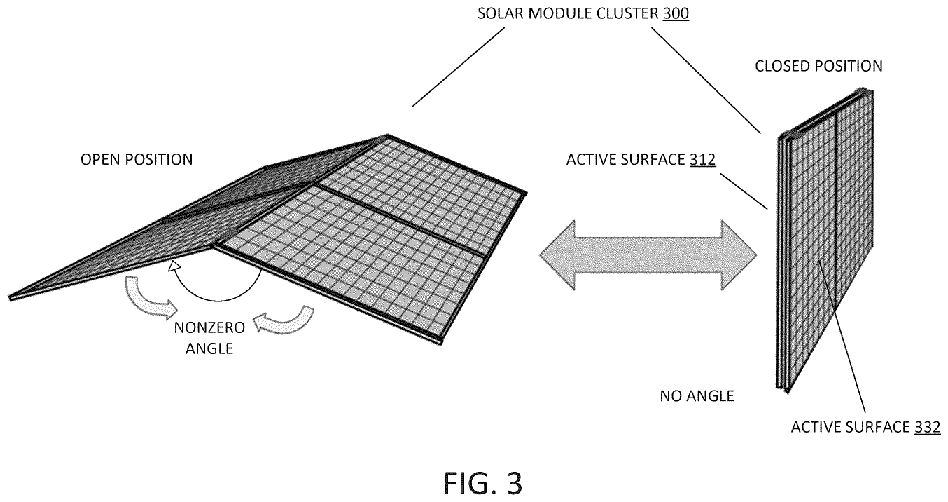

FIG. 3 depicts an example solar module cluster 300 configurable to move between an open-book position (wherein solar module cluster 300 has a nonzero angle) and a closed-book position (wherein solar module cluster 300 has no angle), according to an embodiment. Solar module cluster 300 can be structurally and/or functionally similar to solar module cluster 200 of FIG. 2 and/or solar module cluster 100 of FIG. 1. Solar module cluster 300 includes active surface 312 and active surface 332. Active surface 312 can be an active solar surface of at least a first solar module of solar module cluster 300 and active surface 332 can be an active solar surface of at least a second solar module of solar module cluster 300, where a hinge line is disposed between the first solar module and the second solar module. As shown in FIG. 3, in some implementations, when solar module cluster 300 is configured and/or positioned in the closed-book position, each of active surface 312 and active surface 332 can be positioned on the outside of solar module cluster 300. Stated similarly, active surface 312 can be opposite to active surface 332 when solar module cluster 300 is configured in the closed-book configuration. Conversely, in an alternative embodiment, when solar module cluster 300 is configured in the closed-book position, an inactive surface of a first solar module of solar module cluster 300 can face an inactive surface of a second solar module of solar module cluster 300.

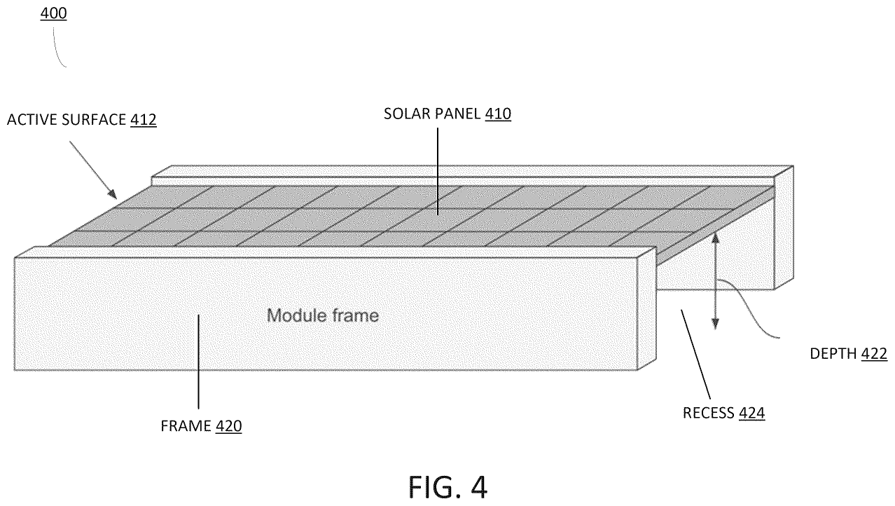

FIG. 4 depicts an example solar module 400 with a frame depth behind a solar panel, according to an embodiment. Solar module 400 can be structurally and/or functionally similar to the solar modules described with respect to any of the embodiments of FIGS. 1-3. Solar module 400 includes solar panel 410 and frame 420. Solar panel 410 can be mechanically coupled to frame 420. Solar panel 410 includes active surface 412 and an inactive surface (not shown) that is opposite to active surface 412.

Frame 420 has depth 422 relative to the inactive surface of solar panel 410. Accordingly, depth 422 is also referred to herein as an inactive side depth. Frame 420 defines recess 424 that is associated with depth 422. Stated similarly, recess 424 can have a spatial dimension, spatial area, and/or spatial volume that is at least partially defined by depth 422. In some implementations, solar module 400 can include electronics (e.g., electronic components, electronic circuits, hardware, etc.) configured to support operation of solar panel 410. For example, the electronics can include microinverters, power optimizers, and/or other suitable electronics for processing an output (e.g., an output power) of solar panel 410. In some implementations, the electronics can be disposed in recess 424. In some implementations, the electronics can be mechanically coupled to portions of solar module 400 that are associated with recess 424, such as portion(s) of frame 420 or solar panel 410 that form (or define) a boundary of recess 424.

In some implementations, frame 420 has a depth relative to the active surface of solar panel 410 (accordingly, such a depth is also referred to herein as an active side depth). The active side depth can be sufficiently shallow (or small, short) such that a portion of frame 420 protrudes only slightly beyond (e.g., above) the active surface of solar panel 410. Conversely, the inactive side depth can be sufficiently deep (or large, long) such that a different (or remaining) portion of frame 420 protrudes significantly beyond (e.g., below) the active surface of solar panel 410 and/or significantly beyond (e.g., above) the inactive surface of solar panel 410.

In some implementations, frame 420 can have a depth of between about 30 mm and about 40 mm, and is substantially flush with, or within a few mm of, the active/sun-facing surface of the solar panel 410, to minimize or avoid casting any shadow on the sun-facing surface. The solar panel 410 itself can be, for example, between about 5 mm and about 7 mm thick, such that from the back (ground-facing) side of the solar panel 410, the frame extends below/beyond the back surface of the solar panel 410 by between about 25 mm and about 35 mm. When two such solar modules 400 are positioned (e.g., folded together) back to back, a spacing of between about 50 mm and about 70 mm can be defined between the solar modules 400, and electronics may be stored within the associated volume between the solar modules 400.

FIG. 5 depicts an example solar module cluster 500 with included space behind solar panels, according to an embodiment. Solar module cluster 500 is also referred to herein as a space-enclosing clamshell solar module cluster. Solar module cluster 500 includes solar module 501 (e.g., structurally and/or functionally similar to solar module 400 of FIG. 4), solar module 503 (e.g., structurally and/or functionally similar to solar module 400 of FIG. 4), hinge 550, and hinge 560. Hinge 550 and hinge 560 can each rotatably couple solar module 501 to solar module 503. Hinge 550 and hinge 560 can each be disposed at separate portions of solar module cluster 500 that form hinge axis 570. Solar module 501 includes solar panel 510 (e.g., structurally and/or functionally similar to solar panel 410 of FIG. 4) and frame 520 (e.g., structurally and/or functionally similar to frame 420 of FIG. 4).

As shown in FIG. 5, when solar module cluster 500 is positioned in and/or configured in (or moved to) a closed-book position, a distance (or spatial area, spatial volume, etc.) exists between the back (or inactive side, inactive surface) of solar panel 510 and the back (or inactive side, inactive surface) of the solar panel 530. FIG. 5 shows a section of a clamshell solar module cluster in the closed-book position, illustrating the space between the two solar panels, inside the clamshell solar module cluster. Accordingly, when in the closed-book position, solar module cluster 500 can define space 505. In some implementations, electronics such as microinverters and/or power optimizers can be disposed in (e.g., enclosed by) a space-enclosing clamshell solar module cluster, in space 505. In some implementations, electronics such as microinverters and/or power optimizers can be protected by coupling (e.g., mounting, etc.) them to inside portions of solar module cluster 500.

The closed-book position of solar module cluster 500 can facilitate the transportation of and deployment of solar module cluster 500. While the arrangement/configuration of a space-enclosing clamshell solar module cluster separates the active solar surfaces of the array from each other, depending on the arrangement/configuration of the solar modules, a risk of micro-damage to the active solar surfaces can exist during transportation. Because some solar module frames protrude only minimally above the active solar surface, transportation-induced vibration of the solar panels may be enough to cause the active solar surfaces of adjacent clamshell solar module clusters to touch each other, causing scuffing or scratching of the active solar surfaces. This can be mitigated by putting, for example, an elastic member in the form of, for example, a thin protective sheet (e.g., including polystyrene foam, such as Styrofoam™, and/or cardboard) between them. In some embodiments, for example, a first instance of solar module cluster 500 and a second instance of solar module cluster 500 can each be in a closed-book configuration and can each be disposed such that an active surface of the first instance of solar module cluster 500 faces an active surface of the second instance of solar module cluster 500. In some such implementations, an elastic member can be disposed between the active surface of the first instance of solar module cluster 500 and the active surface of the second instance of solar module cluster 500. The elastic member can protect the first instance of solar module cluster 500 and the second instance of solar module cluster 500 during, for example, transportation.

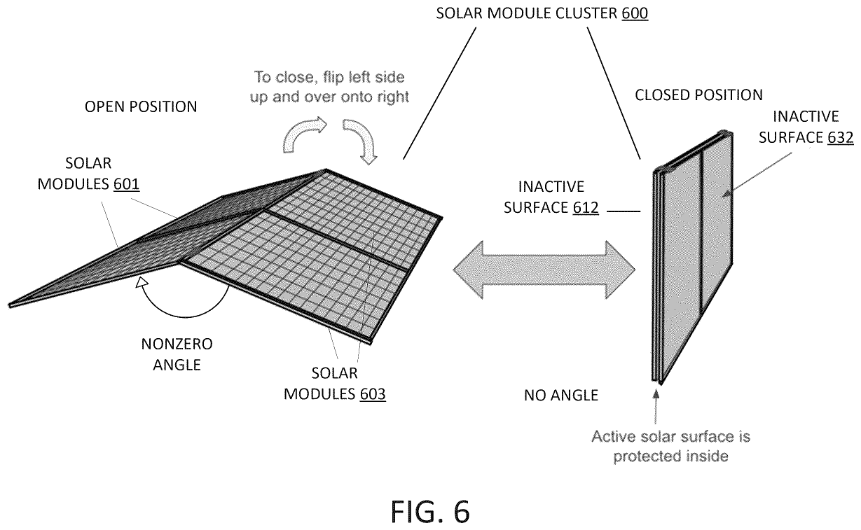

FIG. 6 depicts an example solar module cluster 600 configurable to move between an open-book position (where solar module cluster 600 has a nonzero angle) and a closed-book position (where solar module cluster 600 has no angle), according to another embodiment. Solar module cluster 600 includes inactive surface 612 and inactive surface 632. The solar module cluster 600 is also referred to herein as a reverse clamshell solar module cluster. A reverse clamshell solar module cluster is similar to a space-enclosing clamshell solar module cluster, as described above, except that when solar module cluster 600 is in a closed-book configuration the active solar surfaces are on the inside. Stated similarly, inactive surface 612 can be opposite to inactive surface 632 when solar module cluster 600 is configured in the closed-book configuration. Conversely, when solar module cluster 600 is configured in the closed-book position, an active surface of a first solar module of solar module cluster 600 can face an active surface of a second solar module of solar module cluster 600.

FIG. 6 illustrates solar module cluster 600 being in an open-book configuration and solar module cluster 600 being in a closed-book configuration. In some implementations, solar modules 601 can be lifted up and over relative to solar modules 603 such that solar modules 601 are folded onto solar modules 603. When solar modules 601 is folded onto solar modules 603, the active solar surfaces of each of solar modules 601 and solar modules 603 are positioned on the inside of solar module cluster 600, forming the closed-book configuration of solar module cluster 600.

In some implementations, a reverse clamshell solar module cluster can at least partially protect active solar surface(s) during transportation and/or deployment. When deploying a clamshell solar module cluster in the field, user(s) may decide to put the folded clamshell solar module cluster directly on the ground before unfolding it to its open-book configuration. With a space-enclosing clamshell solar module cluster (e.g., solar module cluster 500 of FIG. 5), this would result in placing the active solar surfaces on one side of the hinge line directly on the ground. The active solar surfaces could thus potentially be broken or damaged by rocks or other hard objects on the ground.

The reverse clamshell solar module cluster (e.g., solar modular cluster 600) can be placed on the ground, when closed, with much less risk to the active solar surfaces, which are protected inside the closed reverse clamshell solar module cluster.

While the active solar surfaces are more protected during field deployment (e.g., when solar module cluster 600 is in the open-book configuration), depending on the arrangement/configuration of the solar modules, a risk of micro-damage to the active solar surfaces can exist during transportation. Because some solar module frames protrude only minimally above the active solar surface, transportation-induced vibration of the solar panels can be enough to cause the active solar surfaces to touch each other, causing scuffing or scratching of the active solar surfaces. Such a risk can be mitigated by putting an elastic member in the form of, for example, a thin protective sheet (e.g., including polystyrene foam, such as Styrofoam™, and/or cardboard) between an active surface of solar modules 601 and an active surface of solar module 603.

In a space-enclosing clamshell solar module cluster (e.g., solar module cluster 500), when the clamshell solar module cluster is in the closed-book configuration, electronics such as microinverters (and/or power optimizers) are naturally protected because they are in the protected space (e.g., space 505 of FIG. 5) between the solar panels of the solar module cluster.

In a reverse clamshell solar module cluster, however, when the clamshell solar module cluster is in the closed-book configuration, electronics such as microinverters and/or power optimizers can be exposed on the outside of the solar module cluster.

During transportation this may not create an issue. During transportation a set of space-enclosing clamshell solar module clusters can include layers of solar modules having alternating orientations, with the power conversion devices (PCS) (e.g., microinverters, power optimizers, etc.) stored and protected in between, for example, back-to-back modules that are sufficiently spaced apart to accommodate the PCS device(s) when secured for transportation and/or when stowed. A set of reverse clamshell solar module clusters is similar in this regard except that the placement of the hinges can be different.

FIG. 7 depicts an example centipede array 700 configurable to be deployed on uneven ground, according to an embodiment. FIG. 7 shows how a centipede array could be arranged. Centipede array 700 includes solar module cluster 701, solar module cluster 702, solar module cluster 703, solar module cluster 704, solar module cluster 705, and solar module cluster 706 (collectively referred to as “the solar module clusters” of centipede array 700). Because centipede array 700 includes a plurality of solar module clusters, each solar module cluster can conform to the local topography. This can result in somewhat different orientations for each solar module cluster from the solar module clusters. For example, solar module cluster 701 is depicted as having at least one apex that has a distance (or height) above a surface (not shown) that is different from a distance (or height) of at least one apex of the remaining solar module clusters. Relatedly, solar module cluster 701 is depicted as having a relative angle that is different from at least one relative angle of the remaining solar module clusters. Further, solar module cluster 701 is depicted as having a a hinge axis that is different from at least one a hinge axis of the remaining solar module clusters.

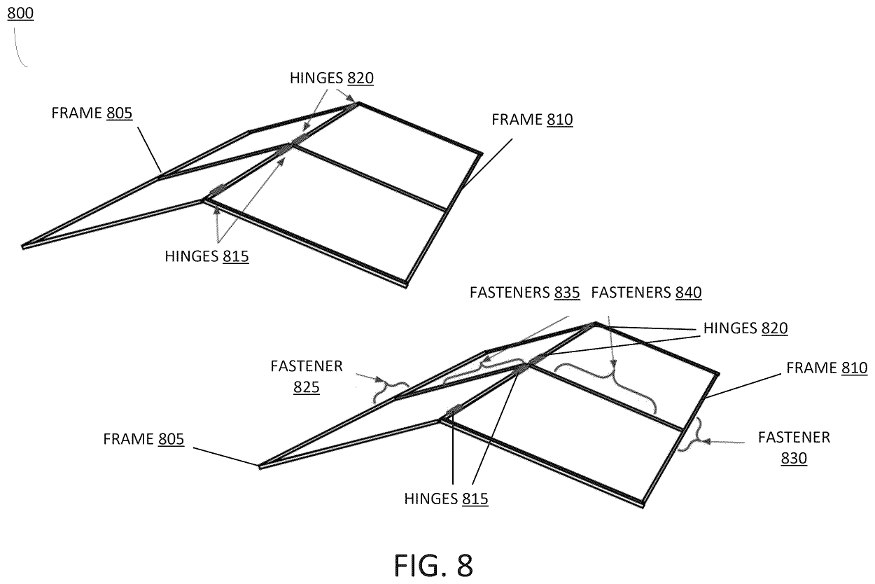

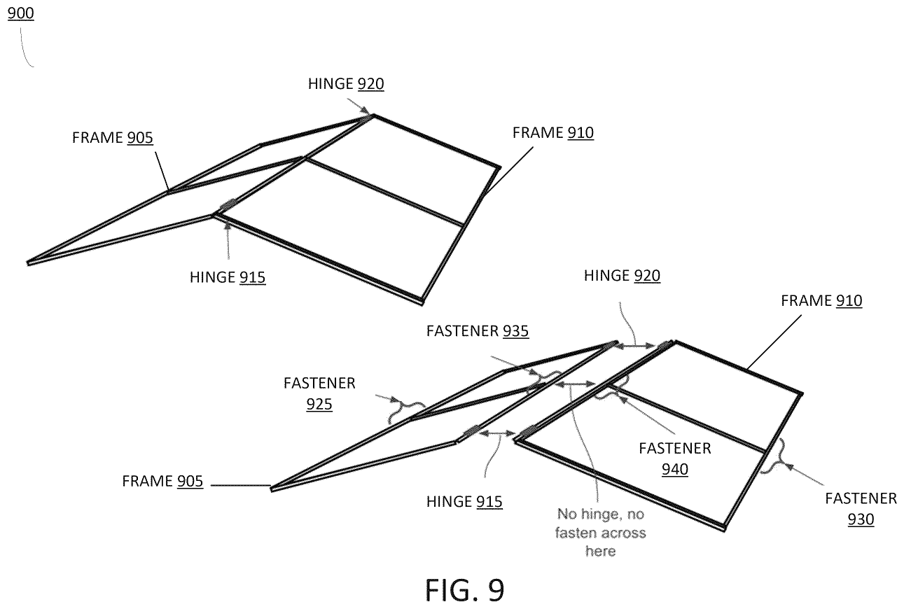

The structural rigidity of a clamshell solar module cluster can depend on the rigidity of the solar module frames, how they are connected and/or hinged to each other, and the nature of any underlying support structure. In some implementations, the solar module clusters of centipede array 700 can be relatively rigid clamshell solar module clusters, as described in more detail with respect to FIG. 8. In some implementations, the solar module clusters of centipede array 700 can be relatively flexible clamshell solar module clusters, as described in more detail with respect to FIG. 9.

FIG. 8 depicts an example solar module cluster 800 that is joined and hinged to have relative rigidity, according to an embodiment. FIG. 8 shows an example of how the solar modules in a clamshell solar module cluster can be joined (fastened) and hinged to each other for a relatively rigid structure. Solar module cluster 800 includes frame 805, frame 810, hinges 815, hinges 820, fastener 825, fastener 830, fasteners 835, and fasteners 840. The multiple hinges of each of hinges 815 and hinges 820, fasteners 835, and fasteners 840 (and the relative positions thereof) can each contribute to a relatively rigidity of solar module cluster 800. For illustrative purposes, solar module cluster 800 is depicted without solar panels, but it is understood that frame 805 is configured to mechanically couple to a first set of solar panels and frame 810 is configured to mechanically couple to a second set of solar panels different from the first set of solar panels.

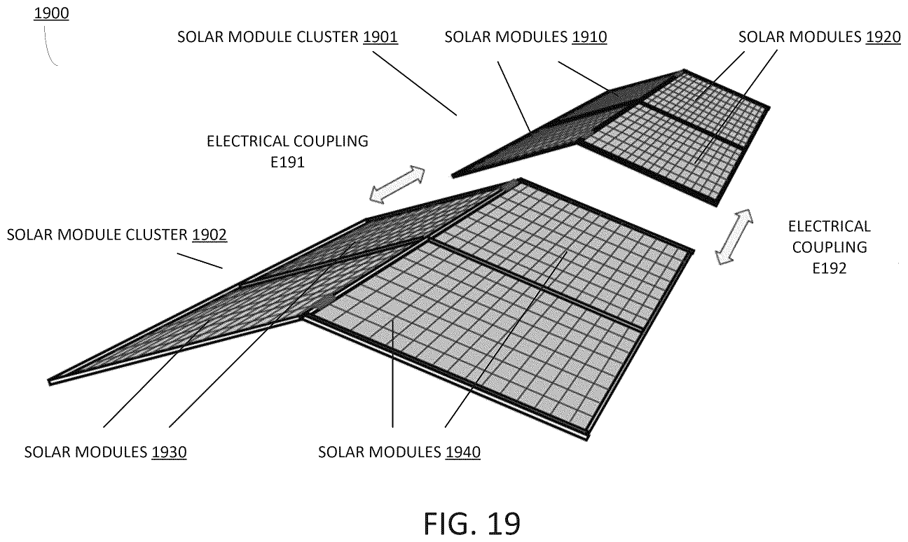

Fasteners can be and/or include any suitable fastener such as, for example, screws, bolts, nuts, washers, nails, rivets, anchors, pins, clips, studs, and/or the like. In some implementations, fasteners can be and/or include a rigid beam, such as an L-section (L-shaped) or U-section (U-shaped) rigid (e.g., metal) piece, running along and fastened to the edges of the modules to both hold them next to each other and to transfer bending loads across the gap between the two modules. The fasteners can be attached to each module by rivets, screws, bolts, clamps, and/or any other suitable means. The fasteners of FIG. 8 can be implemented, by way of example, as shown and discussed with reference to FIG. 19 below.

As depicted, frame 805 is coupled to frame 810 by hinges 815 and hinges 820. Hinges 815 and hinges 820 each includes two hinges. A first hinge of hinges 815 is disposed at a first endpoint portion of an apex line associated with frame 805 and frame 810, and a second hinge of hinges 815 is disposed at a first midpoint portion of the apex line associated with frame 805 and frame 810. A first hinge of hinges 820 is disposed at a second endpoint portion of the apex line associated with frame 805 and frame 810 and mutually exclusive with (e.g., not overlapping with) the first endpoint portion of the apex line. A second hinge of hinges 820 is disposed at a second midpoint portion of an apex line associated with frame 805 and frame 810 and different from (e.g., no more than partially overlapping) the first midpoint portion of the apex line.

Fastener 825 can mechanically couple an exterior edge portion of frame 805 associated with a first solar panel of a first set of solar panels (not shown in FIG. 8) to an exterior edge portion of frame 805 associated with a second solar panel of the first set of solar panels (not shown in FIG. 8). Fastener 830 can mechanically couple an exterior edge portion of frame 810 associated with a first solar panel of a second set of solar panels (not shown in FIG. 8) to an exterior edge portion of frame 810 associated with a second solar panel of the second set of solar panels (not shown in FIG. 8). Fasteners 835 can include one or more fasteners that mechanically couple interior edge portion(s) of frame 805 associated with a first solar panel of a first set of solar panels (not shown in FIG. 8) to interior edge portion(s) of frame 805 associated with a second solar panel of the first set of solar panels (not shown in FIG. 8). Fasteners 840 can include one or more fasteners that mechanically couple interior edge portion(s) of frame 810 associated with a first solar panel of a second set of solar panels (not shown in FIG. 8) to interior edge portion(s) of frame 810 associated with a second solar panel of the second set of solar panels (not shown in FIG. 8).

FIG. 9 depicts an example solar module cluster 900 that is joined and hinged to have relative flexibility, according to an embodiment. In contrast to FIG. 8, FIG. 9 shows how the solar modules in a clamshell solar module cluster can be joined and hinged to each other for a relatively flexible structure that can adapt/confirm to the shape of the topography on which it is positioned. Solar module cluster 900 includes frame 905, frame 910, hinge 915, hinge 920, fastener 925, fastener 930, fastener 935, and fastener 940. The single hinge 915, the single hinge 920, and the relative position(s) of the fasteners can contribute to the relative flexibility of solar module cluster 900.

As depicted, frame 905 is coupled to frame 910 by hinge 915 and hinge 920. Hinge 915 is disposed at a first endpoint portion of an apex line associated with frame 905 and frame 910. Hinge 920 is disposed at a second endpoint portion of the apex line associated with frame 905 and frame 910 and mutually exclusive with (e.g., not overlapping with) the first endpoint portion of the apex line. In the arrangement/configuration of solar module cluster 900, no hinges exist near the center of solar module cluster 900, for example no hinges exist along the apex line (e.g., hinge line) of solar module cluster 900. Although shown and described as being hinges, either or both of hinge 915 and hinge 920 could instead include an alternative type of mechanical coupling, such as a pin-bolt joint, a slip joint, a strap, etc.

As depicted, fastener 925 can be structurally and/or functionally similar to fastener 825 of FIG. 8, and fastener 930 can be structurally and/or functionally similar to fastener 830 of FIG. 8. Fastener 935 can mechanically couple a portion of frame 905 that is (1) associated with a first solar panel of a first set of solar panels (not shown in FIG. 9) and (2) along the apex line of solar module cluster 900 to a portion of frame 905 that is (a) associated with a second solar panel of the first set of solar panels (not shown in FIG. 9) and (b) along the apex line of solar module cluster 900. Fastener 940 can mechanically couple a portion of frame 910 that is (1) associated with a first solar panel of a second set of solar panels (not shown in FIG. 9) and (2) along the apex line of solar module cluster 900 to a portion of frame 910 that is (a) associated with a second solar panel of the second set of solar panels (not shown in FIG. 9) and (b) along the apex line of solar module cluster 900. In other words, the two modules on the left side (with reference to FIG. 9) of solar module cluster 900 can be fastened to each other where they meet along the apex line, and the two modules on the right side (with reference to FIG. 9) of solar module cluster 900 can be fastened to each other where they meet along the apex line, but the left-side modules and the right-side modules can be left without any hinge or fastening between the two sides at that location. The fasteners of FIG. 9 can be implemented, by way of example, as shown and discussed with reference to FIG. 19 below.

In some implementations, one or more of fastener 925, fastener 930, fastener 925, or fastener 925 can include a fastener that does not force the associated frame edges to stay in/maintain a straight line. In other words, the fastener(s) may be configured to permit movement of the associated frame edges such that they depart from a uniform separation or alignment. The fastener could incorporate a hinge (optionally, a limited angle hinge) that would, for example, allow the frames to bow upward at the joint by at least a small amount—but potentially prevent the frames from bowing downward (to limit/prevent sagging).

The configuration of solar module cluster 900 can allow the clamshell solar module cluster to twist more readily, so that the corners of solar module cluster 900 can be pinned to uneven ground, allowing solar module cluster 900 to adapt through a combination of flexing the module frames and twisting the tray elements relative to each other. For example, if the far right (with reference to FIG. 9) corner of solar module cluster 900 is pulled upwards, the redistribution of stress and strain in solar module cluster 900 can cause hinge 915 and hinge 920 to twist (allowing the far right module to move down relative to the far left module at hinge 920, and the opposite at hinge 915), and can cause the center apex connection point of the two right modules to move away from the center apex connection point of the two left modules.

In some implementations, omitting a central hinge (or other mechanical coupling) between hinge 915 and 920 can create the potential for the solar module cluster 900 array to flex slightly when placed onto an uneven/non-level surface, thereby accommodating a variety of different types of supporting surfaces. For example, if the surface onto which the solar module cluster 900 (e.g., having a “tent”-like shape) is placed is convex is an upward direction (e.g., a top of a hill), then if the frame rails at the four corners on the ground are running parallel to the ground, each “side of the tent” (i.e., the left-side modules and the right-side modules) will be forced to bulge out slightly, causing the uppermost sides/edges (also referred to herein as “rails”) of the frames to separate in the middle. As another example, if one side of the solar module cluster 900 is placed on a convex-upward surface, and the other side of solar module cluster 900 is placed on a convex-downward surface, then one top rail would bow up and the other top rail would bow down. Depending on the implementation, and given that solar panel glass and the frames are relatively rigid, the amount of movement, flex, spacing, etc. may be small, e.g., between about 10 mm and about 50 mm on each side of the solar module cluster 900, or a total of between about 10 mm and about 100 mm. Alternatively or in addition, in some implementations, the flexing, twisting, deformation, bowing, buckling, etc. of the frames of the solar module cluster can be facilitated by the hinges (or other suitable couplers) having a nonzero amount of “play” (or mechanical manipulability, looseness, excess movement, etc.) such that the hinged edges can twist slightly relative to each other. Play can be achieved, for example, by using a short hinge length and a pin that is loose inside the knuckle/barrel of the hinge. In some implementations, the solar module cluster 900 may include one or more “pintle hinges” or “pinned connections,” which have only a single (optionally short) knuckle, and if the pintle (pin) is a bit narrower than the interior of the knuckle it can allow twisting.

In some embodiments, a solar module cluster for placement on rough terrain can include only a single center hinge (optionally a pintle hinge) between a first set of solar panels and a second set of solar panels, without a hinge positioned at either end of an edge formed by an intersection/interface between the first set of solar panels and the second set of solar panels. Such a system/assembly could be shipped with one or more removable, reusable slide-on/off hinges (e.g., one at each end), and once placed at a site for installation, the solar module cluster could be unfolded and the removable hinges could be removed, thereby allowing the assembly to twist into a desired/predefined position. The removable hinges could, in turn, be collected and reused on another batch of assemblies/clusters.

In one or more implementations of embodiments set forth herein, alternatively or in addition to hinges, one or more couplers can include a flexible link(s) such as a chain link(s), a wire link(s), a wire that is clamped at one or multiple points of connection, and/or an articulating connector(s).

In some embodiments, similar to the embodiment shown in FIG. 9, a solar module cluster includes 4 solar modules (e.g., an array of 2×2 solar modules), and while neighbors in the same plane are attached to each other along the apex axis, they are not hinged to the neighbors in the other plane. This configuration creates an increased amount of flexibility relative to what could be achieved using a single solar module running along the apex.

FIG. 10 depicts an example solar module cluster 1000 with a type of cross-tray member, according to an embodiment. Solar module cluster 1000 can be structurally and/or functionally similar to the solar module clusters of any of the embodiments of FIGS. 1-9. Solar module cluster 1000 includes frame 1010, frame 1020, and cross-tray member 1030. Cross-tray member 1030 can mechanically couple frame 1010 to frame 1020 at specified portions of each of frame 1010 and frame 1020. Frame 1010 includes exterior edge portion 1018 and interior edge portion 1016. Exterior edge portion 1018 includes corner portion 1012 and midpoint portion 1014. Frame 1020 includes exterior edge portion 1028 and interior edge portion 1026. Exterior edge portion 1028 includes corner portion 1022 and midpoint portion 1024. Cross-tray member 1030 includes end portion 1032 and end portion 1034. End portion 1032 of cross-tray member 1030 can be mechanically coupled to midpoint portion 1014 of frame 1010. End portion 1034 of cross-tray member 1030 can be mechanically coupled to midpoint portion 1024 of frame 1020.

FIG. 10 shows a cross-tray member that can be used, in some embodiments, to limit the relative angle of a clamshell solar module cluster. Cross-tray member 1030 can be configured to limit an upper bound of relative angle A10 to a predefined value. Cross-tray member 1030 can be fastened to each of the near-end solar modules at half-way along its length (as shown, half-way along the long edge of each module). Cross-tray member 1030 could be fastened to each of the modules at lower end portions of frame 1010 and/or lower end portions of frame 1020 or at any reasonable point along exterior edges of frame 1010 and/or exterior edges of frame 1020, but as cross-tray member 1030 is moved closer to the lower end (e.g., nearer the corner portion 1012 and/or corner portion 1022) of each module it increases the likelihood that cross-tray member 1030 will interfere with the ground on an uneven surface; and as it is moved closer to the apex line (e.g., away from corner portion 1012 and/or corner portion 1022) between the modules, it increases both the tension load on cross-tray member 1030 (countered by greater strength of the member) and both the tension load and bending moment on the attachment point on each solar module (countered by greater material strength for the solar module frame). An attachment point near the mid-point (e.g., midpoint portion 1014 and/or midpoint portion 1024) of the solar module frame (e.g., defined by frame 1010 and frame 1020) is likely to be desirable in most cases.

In some implementations, a second instance of cross-tray member 1030 can be positioned at (or near) an exterior edge portion (not shown) of the distal end (with reference to FIG. 9) of solar module cluster 1000. In some implementations, a first end portion of a third instance of cross-tray member 1030 can be mechanically coupled to interior edge portion 1016 of frame 1010 and a second end portion of the third instance of cross-tray member 1030 can be mechanically coupled to interior edge portion 1026 of frame 1020. In other words, an instance of cross-tray member 1030 can be included in the middle portion of solar module cluster 1000 if a hinge exists at a midpoint portion (not shown) of the hinge line of solar module cluster 1000.

Cross-tray member 1030 can be and/or include a cable, fixedly coupled (e.g., permanently attached) to each of frame 1010 and frame 1020. Cross-tray member 1030 can be fixedly coupled to frame 1010 and frame 1020 by making an eye (not shown) at each end of the cable (for example, by passing the cable around a thimble (not shown) and swaging it back on itself), then passing a bolt (not shown) through the thimble and either directly into frame 1010 (or frame 1020) or, alternatively, into a clamp coupled (e.g., affixed) to the frame 1010 (or frame 1020) (so as to avoid piercing frame 1010 and/or frame 1020). In some implementations, cross-tray member 1030 can be installed onto the solar module cluster 1000 in the factory rather than the field. Alternatively or in addition, in some implementations, cross-tray member 1030 can be or include a cable and/or rigid rod that is clipped or clamped to the solar modules in the field, e.g., during a time when the clamshell module cluster is deployed onto a surface. In such instances, it may be useful if the deployment team has something to support the apex of the tray while the cross-tray member is fitted.

FIG. 11 depicts an example solar module cluster 1100 with another type of cross-tray member, according to an embodiment. Solar module cluster 1100 can be structurally and/or functionally similar to any of the embodiments of FIGS. 1-10. Solar module cluster 1100 includes frame 1110, frame 1120, and cross-tray member 1130. Cross-tray member 1130 can mechanically couple frame 1110 to frame 1120 at specified portions of each of frame 1110 and frame 1120. Frame 1110 includes exterior edge portion 1118 and interior edge portion 1116. Exterior edge portion 1118 includes corner portion 1112 and midpoint portion 1114. Frame 1120 includes exterior edge portion 1128 and interior edge portion 1126. Exterior edge portion 1128 includes corner portion 1122 and midpoint portion 1124. Cross-tray member 1130 includes end portion 1132 and end portion 1134. End portion 1132 of cross-tray member 1030 can be mechanically coupled to midpoint portion 1114 of frame 1110. End portion 1134 of cross-tray member 1130 can be mechanically coupled to midpoint portion 1124 of frame 1120.

Cross-tray member 1130 can be and/or include a rigid rod and/or a hinged rod, fixedly coupled (e.g., permanently attached) to each of frame 1110 and frame 1120. Cross-tray member 1130 can be fixedly coupled to each of frame 1110 and frame 1120 via, for example, a first hinge at end portion 1132, a second hinge at end portion 1134, and a third hinge at a midpoint portion of cross-tray member 1130. In FIG. 11, a small angle exists between the two sides of cross-tray member 1130, illustrating the arrangement when the tray has not been fully opened. More specifically, a small angle exists between (1) a first side of cross-tray member 1130 that is bounded by (a) the hinge at end portion 1132 and (b) a hinge at a midpoint of cross-tray member 1130, and (2) a second side of cross-tray member 1130 that is bounded by (c) the hinge at the midpoint of cross-tray member 1130, and (d) the hinge at end portion 1134. In some implementations, cross-tray member 1130 can be installed onto solar module cluster 1100 at the factory, rather than in the field. Alternatively or in addition, in some implementations, cross-tray member 1130 can be or include a rigid rod that is clipped or clamped to the solar modules in the field, e.g., during a time when the clamshell module cluster is deployed onto a surface. In such instances, it may be useful if the deployment team has something to support the apex of the tray while the cross-tray member is fitted.

FIG. 12 depicts a system 1200 for supporting a solar module cluster, according to an embodiment. System 1200 includes solar module cluster 1201 and base 1202. Solar module cluster 1201 can be structurally and/or functionally similar to any of the embodiments of FIGS. 1-11. In some implementations, solar module cluster 1201 and base 1202 can be coupled (e.g., mechanically coupled, removably mechanically coupled). In some implementations, base 1202 can mechanically support solar module cluster 1201, for example, above an uneven surface or an ungraded or naturally graded surface of the land. Base 1202 can be disposed between a surface and solar module cluster 1201. Solar module cluster 1201 includes solar modules 1203, solar modules 1204, hinge 1220 and hinge 1230. In some implementations, base 1202 can mechanically support a portion of solar module cluster 1201 that includes hinge 1220. Stated similarly, base 1202 can be positioned to be at least partially aligned with hinge 1220, to be collocated with hinge 1220. Base 1202 can have a substantially truncated tapered (e.g., conical) shape. Accordingly, base 1202 is also referred to herein as a substantially truncated tapered structure.

Base 1202 includes lower surface 1211 and upper surface 1212. Lower surface 1211 and upper surface 1212 can each have a substantially circular cross-sectional shape. Lower surface 1211 can have a surface area that is smaller than a surface area of upper surface 1212. Upper surface 1212 can define opening 1213. Opening(s) can permit a first instance of base 1202 to be stacked with a second instance of base 1202. In some instances, upper surface 1212 can be cut at one or more angles that match a slope of an under-surface of the solar module cluster 1201 to define one or more open portions of upper surface 1212. For example, opening 1213 can include open portion 1214 and open portion 1215. As depicted in FIG. 12, when base 1202 is positioned beneath the clamshell solar module cluster 1201 and supporting the clamshell solar module cluster 1201, the righthand pair of solar modules (e.g., solar modules 1203) can be substantially supported by a first angled portion (e.g., open portion 1215) of base 1202, and the lefthand pair of solar modules (e.g., solar modules 1204) can be substantially supported by a second angled portion (e.g., open portion 1214) of base 1202 different from the first angled portion. The righthand pair of solar modules (e.g., solar modules 1203) can have a first angle relative to a vertical axis line of the clamshell solar module cluster 1201, and the lefthand pair of solar modules (e.g., solar modules 1204) can have a second angle relative to the vertical axis line of the clamshell solar module cluster 1201, the second angle different from the first angle. An angle of open portion 1215 of base 1202 can be the same as or similar to the first angle, and an angle of open portion 1214 of base 1202 can be the same as or similar to the second angle.

As used herein, a base that “substantially supports” a solar module cluster (or components thereof) with respect to earth's surface (ground) is understood to refer to mechanical support that—in combination with one or more other supports as may be desired or necessary—can support most or all of the weight of the module cluster (although some portion of the weight may be supported by portions of the solar module frames that are in contact with the ground). A flat bottom of the mechanical support creates a large load-bearing area and limits or prevents the assembly from sinking into the ground when the ground is soft and/or wet due to, e.g., rain. The flat bottom is why the tapered supports are shown as getting broader upward: the tops are open and they can stack inside each other, e.g., for transportation. There may be drain holes in the mechanical supports, to prevent them from filling up with water in the rain. Since the solar module frames may be relatively thin, they may tend to sink into the ground during rainfall; the flat load-bearing surface of the mechanical support base can resist this or prevent such sinking from occurring.

Although not visible in FIG. 12, in some implementations, a first instance of base 1202 can be positioned at a proximal end (e.g., a portion that includes hinge 1220) of the clamshell solar module cluster 1201, and a second instance of base 1202 can be positioned at a distal end (e.g., a portion that includes hinge 1230) of the clamshell solar module cluster 1201. Alternatively or in addition, in some implementations, a third instance of base 1202 can be positioned at or near a center portion of the apex line of the clamshell solar module cluster 1201. Alternatively or in addition, in some implementations, two or more instances of base 1202 can be positioned between the proximal end of the clamshell solar module cluster 1201 and the distal end of the clamshell solar module cluster 1201.

As used herein, a substantially truncated tapered shape (or structure) refers to a structure that appears as a tapered three-dimensional shape but permits minor geometric deviations, such that one or more defining dimensions (e.g., base radius, top radius, cone angle, height, etc.) can differ from those of an ideal truncated tapered shape by no more than a small tolerance (e.g., 0.25%, 0.5%, 1%, etc.). Such a definition can extend to other substantially truncated shapes, such as a substantially truncated rectangular shape. Relatedly, a substantially circular cross-section refers to a cross-section that appears as a circle but permits minor geometric deviations, such that a measured profile of a base can differ from that of an ideal circular profile by no more than a small tolerance (e.g., 0.25%, 0.5%, 1%, etc.). Such a definition can extend to other cross-sectional shapes, such as a substantially rectangular cross-section.

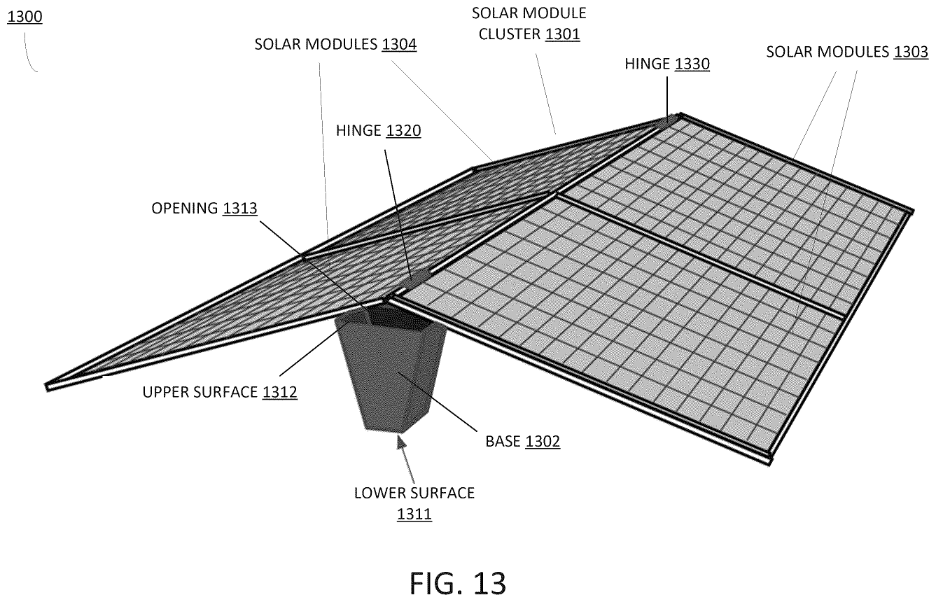

FIG. 13 depicts another system 1300 for supporting a solar module cluster, according to an embodiment. System 1300 includes solar module cluster 1301 and base 1302. Solar module cluster 1301 can be structurally and/or functionally similar to any of the embodiments of FIGS. 1-12. In some implementations, solar module cluster 1301 and base 1302 can be coupled (e.g., mechanically coupled, removably mechanically coupled). In some implementations, base 1302 can mechanically support solar module cluster 1301, for example, above an uneven surface or an ungraded or naturally graded surface of the land. Base 1302 can be disposed between a surface and solar module cluster 1301. Solar module cluster 1301 includes solar modules 1303, solar modules 1304, hinge 1320 and hinge 1330. In some implementations, base 1302 can mechanically support a portion of solar module cluster 1301 that includes hinge 1320. Stated similarly, base 1302 can be positioned to be at least partially aligned with hinge 1320, to be collocated with hinge 1320. Base 1302 can have a substantially truncated rectangular shape. Accordingly, base 1302 is also referred to herein as a substantially truncated rectangular structure.

Base 1302 includes lower surface 1311 and upper surface 1312. Lower surface 1311 and upper surface 1312 can each have a substantially rectangular cross-sectional shape. Lower surface 1311 can have a surface area smaller than a surface area of upper surface 1312. Upper surface 1312 can define opening 1313. Opening(s) can permit a first instance of base 1302 to be stacked with a second instance of base 1302. FIG. 13 shows a variant of the stackable cones concept, having a rectangular cross-section rather than a circular cross-section as shown in FIG. 12. Although shown and described herein as having a rectangular or circular cross-section, a base (or support) for a solar modular cluster can have or include other cross-section shapes (e.g., polygonal, oval, ellipse shaped, hexagonal, triangular, symmetric or asymmetric, etc.).

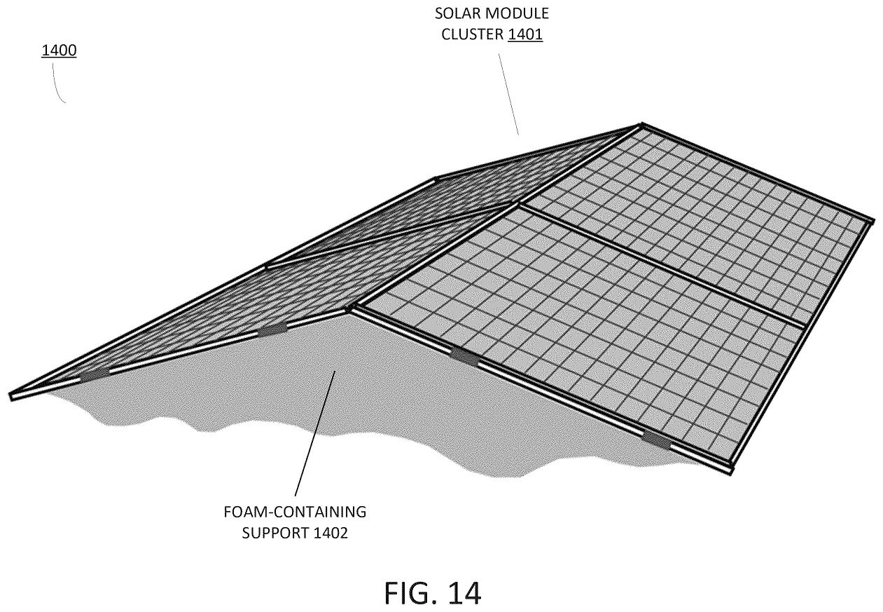

FIG. 14 depicts yet another system 1400 for supporting a solar module cluster, according to an embodiment. System 1400 includes solar module cluster 1401 and foam-containing support 1402. Solar module cluster 1401 can be structurally and/or functionally similar to any of the embodiments of FIGS. 1-13.

Foam-containing support 1402 can be a terrain-following support, in accordance with some embodiments. The bottom of the foam-containing support 1402 can conform to the shape of underlying terrain, such that the land surface need not be graded.

Foam-containing support 1402 can be made, for example, from an expanding foam that is sprayed into a form placed on the surface of the ground for the purpose. Foam-containing support 1402, in turn and along a bottom surface thereof, can conform to the land surface without allowing excessive foam leakage. Foam-containing support 1402 can facilitate the ability of solar module cluster 1401 to be positioned on different types of terrain. For example, a first instance of solar module cluster 1401 with a first instance of foam-containing support 1402 can be positioned on a first ungraded or naturally graded surface of land, and a second instance of solar module cluster 1401 with a second instance of foam-containing support 1402 can be positioned on a second ungraded or naturally graded surface of land that is different from the first ungraded or naturally graded surface of land.

In some implementations, foam boards may be pre-cut with a desired “tent” angle at the top, and the foam boards may be configured to clip onto a solar module cluster, to form a gable(s). At the bottom, a foam board might rest on the ground (when placed on an uneven ground surface) at only a few points, with gaps underneath everywhere else. Optionally, to provide additional support, keep wildlife out and/or to prevent erosion due to water flowing through those gaps, closed-cell polyurethane spray foam (e.g., having a formulation that is safe/designed for contact with soil) could be spray-applied along the interface between the gable(s) and the ground. The foam would then expand and fill the gaps

FIG. 15 shows a cross-section of a system 1500 for anchoring a clamshell solar module cluster, in accordance with some embodiments. System 1500 includes solar module 1501 and earth anchor 1502. Earth anchor 1502 can mechanically support solar module 1501 at a specified distance above a surface (e.g., an uneven surface, an ungraded or naturally graded surface of the land, etc.). In some implementations, earth anchor 1502 can anchor/secure a solar module cluster that includes solar module 1501 in a manner that prevents the solar module cluster from being lifted by strong winds or moved by flood waters. Solar module 1501 can be included in a solar module cluster (not shown) that is structurally and/or functionally similar to any of the embodiments of FIGS. 1-14. Solar module 1501 includes frame 1540. Frame 1540 includes bottom edge portion 1542. Earth anchor 1502 includes eye 1510, ground screw 1520, and lifting clip 1530. Eye 1510 includes eye outer portion 1512. Ground screw 1520 includes stop 1522.

The apex line (not shown) of the clamshell solar module cluster (not shown) that includes solar module 1501 is off to the left, from the point of view shown in FIG. 15. A portion of eye 1510 attached to frame 1540 and eye outer portion 1512 are, respectively, the left and right sides of the eye 1510 through which the ground screw 1520 passes. The eye 1510 can be mechanically coupled to frame 1540 by one or more of: a clamp, a bolt, a rivet, or any other suitable means. The ground screw 1520 can be passed through the eye 1510 and screwed into the ground as needed. The lifting clip 1530 can be fitted to the ground screw 1520 and can hold the eye 1510 up above the surface of the earth as needed. The ground screw stop 1522 prevents the eye 1510 from lifting off the top of the ground screw 1520. In combination, eye 1510, ground screw 1520 and lifting clip 1530 can hold the bottom edge portion 1542 of the solar module frame 1540 at a specified distance above the surface of the ground, and prevent solar module 1501 from being lifted away from the ground and/or moved laterally by winds or water.

The lifting clip 1530 can be implemented in a number of ways, including (1) a pin inserted into a hole through the ground screw 1520; (2) a cap placed over the top of the ground screw 1520, with a lower portion that passes under the eye 1510; and/or (3) a tube placed on the ground, through which the ground screw 1520 passes, so that the eye 1510 rests on top of the tube.

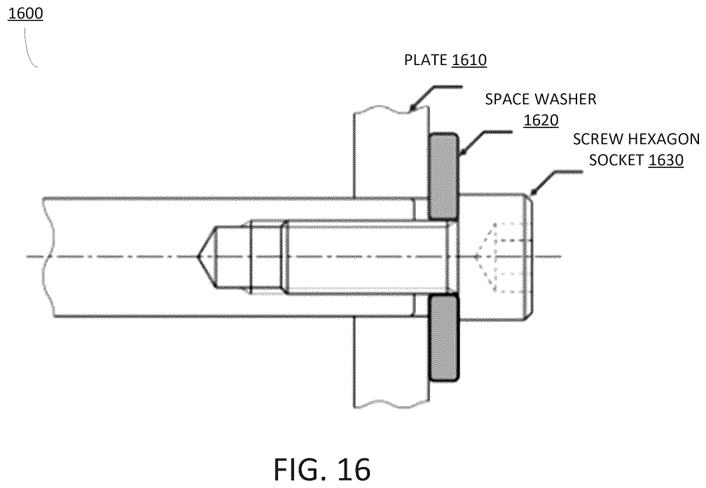

In some implementations, the lifting clip 1530 can be and/or include a washer or other type of spacer. In some implementations, the ground screw stop 1522 can be and/or include a washer or other type of spacer that is optionally connected to the lifting clip 1530. In some implementations, the ground screw stop 1522 can have a C-shaped washer (e.g., as shown in FIG. 16) under the head of ground screw 1520 that has a larger diameter than the shaft of ground screw 1520.

Alternatively or in addition, the ground screw stop 1522 can be or include a U-shaped bracket (“U-bracket”) having a first hole on a first side of the “U” portion of the U-bracket that is large enough for ground screw 1520 to pass through but not large enough for the eye 1510 to pass through. A second side of the “U” portion of the U-bracket opposite the first side can in some instances include a hole (or an absence of a hole), and can rest on top of the ground screw 1520.

FIG. 16 shows a diagram of an example fastener assembly 1600, according to an embodiment. Fastener assembly 1600 (or simply, fastener 1600) can be used, for example, in any of the embodiments of FIGS. 1-15. Fastener assembly 1600 includes plate 1610, space washer 1620, and screw hexagon socket 1630. Space washer 1620 can be disposed around screw hexagon socket 1630 and disposed against plate 1610. In some implementations, space washer 1620 can be a portion of a ground screw stop (e.g., ground screw stop 1522 of FIG. 15) for a ground screw (e.g., ground screw 1520 of FIG. 15). In some implementations, screw hexagon socket 1630 can be a hexagon socket for a ground screw (e.g., ground screw 1520 of FIG. 15). In some implementations, plate 1610 can be a portion of an eye (e.g., eye 1510 of FIG. 15).

FIG. 17 is a wiring diagram 1700 for a 2×2 solar module cluster, according to an embodiment. The wiring diagram 1700 can be representative of an electrical configuration for a solar module cluster of any of the embodiments of FIGS. 1-15. For example, wiring diagram 1700 can be representative of an electrical configuration of a clamshell solar module cluster that is embodied as a 2×2 solar module cluster, as shown in at least FIGS. 1-3 above, with two solar modules on each side of the hinge line. In some implementations, the power from such solar modules can be converted to alternating current (AC) by a single microinverter with sufficient capacity for four solar modules, where the single microinverter has two Maximum Power Point Tracking (MPPT) inputs. In some such implementations, the two solar modules on one side of the hinge line can be electrically connected to one of the MPPT inputs and the two solar modules on the other side of the hinge line can be electrically connected to the other MPPT input.

The wiring diagram 1700 is representative of an electrical configuration for a solar module cluster including solar module 1720, solar module 1722, solar module 1724, solar module 1726, and electronics 1750. In some implementations, a hinge line (not shown in FIG. 17) of the solar module cluster can be disposed between (1) solar module 1720 and solar module 1722 and (2) solar module 1724 and solar module 1726. Electronics 1750 includes microinverter 1730 and microinverter 1740. Microinverter 1730 can be disposed between (and can electrically couple) alternating current (AC) bus 1710 to each of solar module 1720 and solar module 1722. Microinverter 1740 can be disposed between (and can electrically couple) AC bus 1710 to each of solar module 1724 and solar module 1726. Solar module 1720 and solar module 1722 can be electrically coupled (e.g., wired) in series to form the DC input to MPPT 1751. Microinverter 1730 can convert the DC input associated with MPPT 1751 to an AC output that can be input to AC bus 1710. Solar module 1724 and solar module 1726 can be electrically coupled (e.g., wired) in series to form the DC input to MPPT 1752. Microinverter 1740 can convert the DC input associated with MPPT 1752 to an AC output that can be input to AC bus 1710. Connectors at each end of the clamshell solar module cluster can allow a first instance of the AC bus 1710 to be connected to one or more second instances of the AC bus 1710 of the adjacent clamshell solar module clusters (if any).

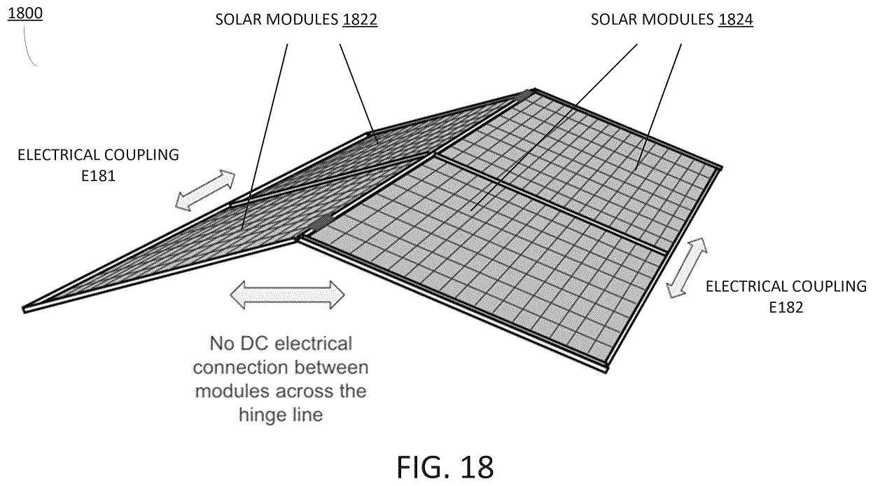

FIG. 18 depicts an example solar module cluster 1800 with a type of DC wiring, according to an embodiment. Solar module cluster 1800 can be structurally and/or functionally similar to any of the embodiments of FIGS. 1-14 and FIG. 17. Solar module cluster 1800 includes solar modules 1822 and solar modules 1824. Solar modules 1822 can be disposed on one side of a hinge line of solar module cluster 1800 and solar modules 1824 can be disposed on an opposite side of the hinge line of solar module cluster 1800. As depicted, solar modules 1822 can be electrically coupled together (indicated by electrical coupling E181). Solar modules 1824 can be electrically coupled together (indicated by electrical coupling E182). Solar modules 1822 and solar modules 1824 can have an absence of an electrical coupling (e.g., a DC electrical connection) therebetween. In some implementations, a second instance of solar module cluster 1800 can be deployed adjacent to the (first instance of) solar module cluster 1800, so as to share a “common” hinge line. In some such implementations, electrical coupling E181 can extend to solar module(s) of the second instance of solar module cluster 1800 that are on one side of the common hinge line, and electrical coupling E182 can extend to solar module(s) of the second instance of solar module cluster 1800 that are on the opposite side of the common hinge line. Then, as more clamshell solar module clusters are added to the configuration described, electrical connections would be added to continue the wiring from additional solar module cluster to additional solar module cluster so that the wiring would link up the modules on the same side of the hinge line, but not across the hinge line. An example is described with respect to FIG. 19.

FIG. 19 depicts a system 1900 for electrically coupling two or more solar module clusters, according to an embodiment. System 1900 includes solar module cluster 1901 and solar module cluster 1902. Solar module cluster 1901 and solar module cluster 1902 can each be structurally and/or functionally similar to any of the embodiments of FIGS. 1-14 and FIGS. 17-18. Solar module cluster 1901 includes solar modules 1910 and solar modules 1920. Solar module cluster 1902 includes solar modules 1930 and solar modules 1940. Solar modules 1930 and solar modules 1910 can be electrically coupled (indicated by electrical coupling E191), for example, in series. Solar modules 1940 and solar modules 1920 can be electrically coupled (indicated by electrical coupling E192), for example, in series. Solar modules 1930 can have an absence of an electrical coupling with solar modules 1940 and solar modules 1920. Solar modules 1940 can have an absence of an electrical coupling with solar modules 1910 and solar modules 1930. Solar modules 1910 can have an absence of an electrical coupling with solar modules 1920 and solar modules 1940. Solar modules 1920 can have an absence of an electrical coupling with solar modules 1910 and solar modules 1930.

FIG. 20 depicts an example table solar module cluster 2000, according to an embodiment. Table solar module cluster 2000 includes solar module 2001, solar module 2002, solar module 2003, solar module 2004, fastener 2012, fastener 2021, fastener 2023, fastener 2032, fastener 2034, and fastener 2043 (collectively referred to as the fasteners). The fasteners can be structurally and/or functionally similar to the fasteners described herein, for example, at least with respect to FIG. 16. Fastener 2012 and fastener 2021 can each mechanically couple solar module 2001 to solar module 2002. For example, fastener 2012 can couple a first exterior edge portion of solar module 2001 to a first exterior edge portion of solar module 2002 and fastener 2023 can couple a second exterior edge portion of solar module 2001 to a second exterior edge portion of solar module 2002. Fastener 2023 and fastener 2032 can each mechanically couple solar module 2002 to solar module 2003. For example, fastener 2023 can couple a first exterior edge portion of solar module 2002 to a first exterior edge portion of solar module 2003 and fastener 2032 can couple a second exterior edge portion of solar module 2002 to a second exterior edge portion of solar module 2003. Fastener 2034 and fastener 2043 can each mechanically couple solar module 2003 to solar module 2004. For example, fastener 2034 can couple a first exterior edge portion of solar module 2003 to a first exterior edge portion of solar module 2004 and fastener 2032 can couple a second exterior edge portion of solar module 2003 to a second exterior edge portion of solar module 2004. In some implementations, table solar module cluster 2000 can have an electrical configuration that is functionally and/or structurally similar to or the same as that described herein for one side of a clamshell solar module cluster and with respect to FIGS. 17-19.

In some embodiments, an apparatus includes a first set of solar panels, a second set of solar panels, and an interface. The interface rotatably couples the first set of solar panels to the second set of solar panels such that (1) an edge is defined between a side of the first set of solar panels and a side of the second set of solar panels, and (2) an angular position of the first set of solar panels relative to the second set of solar panels is adjustable, the interface including a first hinge at a first endpoint portion of the edge and a second hinge at a second endpoint portion of the edge that is opposite the first endpoint portion of the edge. The first set of solar panels, the second set of solar panels, and the interface collectively define a solar module configured to be disposed on an uneven surface by virtue of at least one of: (i) the solar module not including a coupler at the midpoint portion of the edge such that the side of the first set of solar panels is movable relative to the side of the second set of solar panels such that the side of the first set of solar panels is not everywhere parallel with the side of the second set of solar panels, (ii) the second set of solar panels further being rotatable, independently of the first set of solar panels, about a rotational axis different from an axis defined by the edge, or (iii) a deformation in at least one of a frame of the first set of solar panels or a frame of the second set of solar panels.

In some implementations, the solar module is configured to be disposed on the uneven surface by virtue of the deformation in the at least one of the frame of the first set of solar panels or the frame of the second set of solar panels, and the deformation includes at least one of a bowing, a bending, or a flexing of the at least one of the frame of the first set of solar panels or the frame of the second set of solar panels.

In some implementations, the apparatus also includes at least one of a microinverter or a power optimizer that is mechanically and electrically coupled to at least one of the first set of solar panels or the second set of solar panels.

In some implementations, the apparatus also includes a set of electronics that is mechanically and electrically coupled to at least one of the first set of solar panels or the second set of solar panels. The apparatus ia configurable between the open position and a closed position, and the electronics is positioned between the first set of solar panels and the second set of solar panels when the apparatus is in the closed position.

In some implementations, the apparatus also includes a substantially rigid connector having a first end portion and a second end portion, the first end being mechanically coupled to the frame of the first set of solar panels and the second end being mechanically coupled to the frame of the second set of solar panels. The substantially rigid connector can be configured to limit the angular position of the first set of solar panels relative to the second set of solar panels to a predefined value.

In some implementations, the apparatus also includes a hinged connector having a first end portion and a second end portion, the first end being mechanically coupled to the frame of the first set of solar panels and the second end being mechanically coupled to the frame of the second set of solar panels. The hinged connector can be configured to limit the angular position of the first set of solar panels relative to the second set of solar panels to a predefined value.

In some implementations, the apparatus also includes one of (i) a hinged connector having a first end portion and a second end portion, the first end being mechanically coupled to the frame of the first set of solar panels and the second end being mechanically coupled to the frame of the second set of solar panels, (ii) at least one rod configured to mechanically couple, via a clip mechanism, to each of the frame of the first set of solar panels and the frame of the second set of solar panels, or (iii) at least one hook configured to mechanically couple the frame of the first set of solar panels to the frame of the second set of solar panels. For example, the apparatus can include one or multiple pairs of rods with hooks on their ends that are clipped to each other during deployment.

In some implementations, the apparatus also includes a support configured (1) to be disposed between (i) each of the first set of solar panels and the second set of solar panels, and (ii) the uneven surface, and (2) to at least partially conform to the uneven surface.

In some implementations, each solar panel from the first set of solar panels is electrically coupled to remaining solar panels from the first set of solar panels, each solar panel from the second set of solar panels is electrically coupled to remaining solar panels from the second set of solar panels, and the first set of solar panels is not electrically coupled to the first second set of solar panels.

In some embodiments, a system includes an alternating current (AC) bus and a plurality of solar module trays. Each solar module tray from the plurality of solar module trays is configured to be electrically coupled to the AC bus. A first solar module tray from the plurality of solar module trays at least one of: (i) includes a first hinge positioned proximal to a first apex of the first solar module tray, and a second hinge positioned at a second apex of the first solar module tray, no hinge being positioned at a midpoint portion between the first apex of the first solar module tray and the second apex of the first solar module tray, (ii) includes an elongate member mechanically attached to each of an edge portion of a first solar module of the first solar module tray and an edge portion of a second solar module of the first solar module tray, (iii) is mechanically coupled to a base having at least one open end such that the base is nestable with at least one further base, or (iv) is mechanically coupled to a foam-containing support, such that the first solar module tray can be positioned on a first naturally graded surface of land. A second solar module tray from the plurality of solar module trays at least one of: (i) includes a first hinge positioned proximal to a first apex of the first solar module tray, and a second hinge positioned at a second apex of the second solar module tray, no hinge being positioned at a midpoint portion between the first apex of the second solar module tray and the second apex of the second solar module tray, (ii) includes an elongate member mechanically attached to each of an edge portion of a first solar module of the second solar module tray and an edge portion of a second solar module of the first solar module tray, (iii) is mechanically coupled to a base having at least one open end such that the base is nestable with at least one further base, or (iv) is mechanically coupled to a foam-containing support, such that the second solar module tray can be positioned on a second ungraded surface of land different from the first ungraded surface of land.

In some implementations, each solar module tray from the plurality of solar module trays includes a first set of solar panels and a second set of solar panels that is rotatably coupled to the first set of solar panels. The system can also include a first microinverter configured to electrically couple the AC bus to the first set of solar panels, and a second microinverter configured to electrically couple the AC bus to the second set of solar panels.

In some implementations, the system also includes an anchor including an eye, a ground screw, and a lifting clip. The eye is configured to be mechanically coupled to the frame of the first solar module tray. The ground screw is configured to be passed through the eye and screwed into the first ungraded surface of land. The lifting clip is configured to fit with the ground screw and mechanically support the eye above the first ungraded surface of the land. The anchor is configured to mechanically support a bottom edge portion of the frame of the first solar module tray at a specified distance above the first ungraded surface of the land.

In some implementations, the first solar module tray is mechanically coupled to the foam-containing support, and the foam-containing support is configured to conform to the first ungraded surface of land.

In some implementations, the first solar module tray is mechanically coupled to a base, and the base has a substantially truncated conical shape.

In some embodiments, an apparatus includes a first solar module, a second solar module, and at least one hinge. The first solar module includes a first set of solar panels, a first frame mechanically coupled to the first set of solar panels, and a first set of electronic circuits that is (1) electrically coupled to the first set of solar panels and (2) mechanically coupled to the first frame. The second solar module includes a second set of solar panels, a second frame mechanically coupled to the second set of solar panels, and a second set of electronic circuits that is (a) electrically coupled to the second set of solar panels and (b) mechanically coupled to the second frame. The at least one hinge rotatably couples the first frame to the second frame. The apparatus is configurable between an open position in which the first solar module and the second solar module form a nonzero angle therebetween, and a closed position in which substantially no angle is formed between the first solar module and the second solar module. The apparatus may not include a coupler at a midpoint portion of an edge formed between the first solar module and the second solar module.

In some implementations, the first frame has a depth relative to an inactive surface of the first set of solar panels, the first frame defining a recess of the first solar module and associated with the depth of the first frame. The second frame can have a depth relative to an inactive surface of the second set of solar panels, the second frame defining a recess of the second solar module and associated with the depth of the second frame. Each of the first set of electronic circuits and the second set of electronic circuits can be disposed within a volume that includes the recess of the first solar module and the recess of the second solar module.

In some implementations, each of the first set of electronic circuits and the second set of electronic circuits includes at least one of (a) one or more microinverters, or (b) one or more power optimizers.

In some implementations, the apparatus also includes a substantially truncated tapered structure with an upper surface and a lower surface. The upper surface defines an opening with (1) a first portion that is angled to substantially match a slope of an inactive surface of a solar panel from the first set of solar panels, and (2) a second portion that is angled to substantially match a slope of an inactive surface of a solar panel from the second set of solar panels. The truncated tapered structure can be configured to mechanically support each of the first solar module and the second solar module during use. The truncated tapered structure can be configured to nest within a further truncated tapered structure during transport.

In some implementations, the set of electronic circuits of the first solar module is disposed with a portion of the first solar module that is collocated with a hinge from the at least one hinge, and the set of electronic circuits of the second solar module is disposed with a portion of the second solar module that is collocated with the hinge from the at least one hinge.

In some implementations, the apparatus also includes a cross-tray member with a first end portion and a second end portion, the first end portion being mechanically coupled to the frame of the first solar module and the second end portion being mechanically coupled to the frame of the second solar module. The cross-tray member can be configured to limit an upper bound of a relative angle between the first solar module and the second solar module to a predefined value.

In some implementations, an active surface of the first set of solar panels faces an active surface of the second set of solar panels when the apparatus is in the closed position, the apparatus further comprising an elastic member disposed between the active surface of the first set of solar panels and the second set of solar panels.

In some implementations, an inactive surface of the first set of solar panels faces an inactive surface of the second set of solar panels when the apparatus is in the closed position.

In some embodiments, an apparatus includes a first set of solar panels, a second set of solar panels, and an interface. The interface rotatably couples the first set of solar panels to the second set of solar panels such that (1) an edge is defined between the first set of solar panels and the second set of solar panels, and (2) an angular position of the first set of solar panels relative to the second set of solar panels is adjustable. The interface includes first and second hinges at endpoint portions of the edge, and the apparatus does not include a coupler at a midpoint portion of the edge. The first set of solar panels, the second set of solar panels, and the interface define a solar module configured to be disposed on an uneven surface.

All combinations of the foregoing concepts and additional concepts discussed herewithin (provided such concepts are not mutually inconsistent) are contemplated as being part of the subject matter disclosed herein. The terminology explicitly employed herein that also may appear in any disclosure incorporated by reference should be accorded a meaning most consistent with the particular concepts disclosed herein.

The drawings are primarily for illustrative purposes, and are not intended to limit the scope of the subject matter described herein. The drawings are not necessarily to scale; in some instances, various aspects of the subject matter disclosed herein may be shown exaggerated or enlarged in the drawings to facilitate an understanding of different features. In the drawings, like reference characters generally refer to like features (e.g., functionally similar and/or structurally similar elements).

The entirety of this application (including the Cover Page, Title, Headings, Background, Summary, Brief Description of the Drawings, Detailed Description, Embodiments, Abstract, Figures, Appendices, and otherwise) shows, by way of illustration, various embodiments in which the embodiments may be practiced. The advantages and features of the application are of a representative sample of embodiments only, and are not exhaustive and/or exclusive. Rather, they are presented to assist in understanding and teach the embodiments, and are not representative of all embodiments. As such, certain aspects of the disclosure have not been discussed herein. That alternate embodiments may not have been presented for a specific portion of the innovations or that further undescribed alternate embodiments may be available for a portion is not to be considered to exclude such alternate embodiments from the scope of the disclosure. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure.

Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure.

The phrase “based on” does not mean “based only on,” unless expressly specified otherwise. In other words, the phrase “based on” describes both “based only on” and “based at least on.”

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

The indefinite articles “a” and “an,” as used herein in the specification and in the embodiments, unless clearly indicated to the contrary, should be understood to mean “at least one.”

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. An apparatus, comprising:
a first set of solar panels;
a second set of solar panels; and
an interface that rotatably couples the first set of solar panels to the second set of solar panels such that (1) an edge is defined between a side of the first set of solar panels and a side of the second set of solar panels, and (2) an angular position of the first set of solar panels relative to the second set of solar panels is adjustable, the interface including a first hinge at a first endpoint portion of the edge and a second hinge at a second endpoint portion of the edge that is opposite the first endpoint portion of the edge,
the first set of solar panels, the second set of solar panels, and the interface defining a solar module configured to be disposed on an uneven surface by virtue of at least one of:
(i) the solar module not including a coupler at the midpoint portion of the edge such that the side of the first set of solar panels is movable relative to the side of the second set of solar panels such that the side of the first set of solar panels is not everywhere parallel with the side of the second set of solar panels,
(ii) the second set of solar panels further being rotatable, independently of the first set of solar panels, about a rotational axis different from an axis defined by the edge, or
(iii) a deformation in at least one of a frame of the first set of solar panels or a frame of the second set of solar panels.

2. The apparatus of claim 1, wherein the solar module is configured to be disposed on the uneven surface by virtue of the deformation in the at least one of the frame of the first set of solar panels or the frame of the second set of solar panels, the deformation including at least one of a bowing, a bending, or a flexing of the at least one of the frame of the first set of solar panels or the frame of the second set of solar panels.

3. The apparatus of claim 1, further comprising at least one of a microinverter or a power optimizer mechanically and electrically coupled to at least one of the first set of solar panels or the second set of solar panels.

4. The apparatus of claim 1, further comprising a set of electronics mechanically and electrically coupled to at least one of the first set of solar panels or the second set of solar panels, the apparatus being configurable between the open position and a closed position, the electronics being positioned between the first set of solar panels and the second set of solar panels when the apparatus is in the closed position.

5. The apparatus of claim 1, further comprising:
a substantially rigid connector having a first end portion and a second end portion, the first end being mechanically coupled to the frame of the first set of solar panels and the second end being mechanically coupled to the frame of the second set of solar panels, the substantially rigid connector configured to limit the angular position of the first set of solar panels relative to the second set of solar panels to a predefined value.

6. The apparatus of claim 1, further comprising at least one of:
a hinged connector having a first end portion and a second end portion, the first end being mechanically coupled to the frame of the first set of solar panels and the second end being mechanically coupled to the frame of the second set of solar panels,
at least one rod configured to mechanically couple, via a clip mechanism, to each of the frame of the first set of solar panels and the frame of the second set of solar panels, or
at least one hook configured to mechanically couple the frame of the first set of solar panels to the frame of the second set of solar panels.

7. The apparatus of claim 1, further comprising:
a support configured (1) to be disposed between (i) each of the first set of solar panels and the second set of solar panels, and (ii) the uneven surface, and (2) to at least partially conform to the uneven surface.

8. The apparatus of claim 1, wherein each solar panel from the first set of solar panels is electrically coupled to remaining solar panels from the first set of solar panels, each solar panel from the second set of solar panels is electrically coupled to remaining solar panels from the second set of solar panels, and the first set of solar panels is not electrically coupled to the first second set of solar panels.

9. A system, comprising:
an alternating current (AC) bus; and
a plurality of solar module trays, each solar module tray from the plurality of solar module trays configured to be electrically coupled to the AC bus,
a first solar module tray from the plurality of solar module trays at least one of:
(i) including a first hinge positioned proximal to a first apex of the first solar module tray, and a second hinge positioned at a second apex of the first solar module tray, no hinge being positioned at a midpoint portion between the first apex of the first solar module tray and the second apex of the first solar module tray,
(ii) including an elongate member mechanically attached to each of an edge portion of a first solar module of the first solar module tray and an edge portion of a second solar module of the first solar module tray,
(iii) being mechanically coupled to a base having at least one open end such that the base is nestable with at least one further base, or
(iv) being mechanically coupled to a foam-containing support, such that the first solar module tray can be positioned on a first naturally graded surface of land, and a second solar module tray from the plurality of solar module trays at least one of:
(i) including a first hinge positioned proximal to a first apex of the first solar module tray, and a second hinge positioned at a second apex of the second solar module tray, no hinge being positioned at a midpoint portion between the first apex of the second solar module tray and the second apex of the second solar module tray,
(ii) including an elongate member mechanically attached to each of an edge portion of a first solar module of the second solar module tray and an edge portion of a second solar module of the first solar module tray,
(iii) being mechanically coupled to a base having at least one open end such that the base is nestable with at least one further base, or
(iv) being mechanically coupled to a foam-containing support, such that the second solar module tray can be positioned on a second ungraded surface of land different from the first ungraded surface of land.

10. The system of claim 9, wherein each solar module tray from the plurality of solar module trays includes a first set of solar panels and a second set of solar panels that is rotatably coupled to the first set of solar panels, the system further comprising:
a first microinverter configured to electrically couple the AC bus to the first set of solar panels; and
a second microinverter configured to electrically couple the AC bus to the second set of solar panels.

11. The system of claim 9, further comprising:
an anchor including an eye, a ground screw, and a lifting clip, the eye configured to be mechanically coupled to the frame of the first solar module tray, the ground screw configured to be passed through the eye and screwed into the first ungraded surface of land, the lifting clip configured to fit with the ground screw and mechanically support the eye above the first ungraded surface of the land,
the anchor configured to mechanically support a bottom edge portion of the frame of the first solar module tray at a specified distance above the first ungraded surface of the land.

12. The system of claim 9, wherein the first solar module tray is mechanically coupled to the foam-containing support, and the foam-containing support is configured to conform to the first ungraded surface of land.

13. The system of claim 9, wherein the first solar module tray is mechanically coupled to a base, and the base has a substantially truncated tapered shape.

14. An apparatus, comprising:
a first solar module including a first set of solar panels, a first frame mechanically coupled to the first set of solar panels, and a first set of electronic circuits that is (1) electrically coupled to the first set of solar panels and (2) mechanically coupled to the first frame;
a second solar module including a second set of solar panels, a second frame mechanically coupled to the second set of solar panels, and a second set of electronic circuits that is (a) electrically coupled to the second set of solar panels and (b) mechanically coupled to the second frame; and
at least one hinge that rotatably couples the first frame to the second frame,
the apparatus configurable between an open position in which the first solar module and the second solar module form a nonzero angle therebetween, and a closed position in which substantially no angle is formed between the first solar module and the second solar module, the apparatus not including a coupler at a midpoint portion of an edge formed between the first solar module and the second solar module.

15. The apparatus of claim 14, wherein:
the first frame has a depth relative to an inactive surface of the first set of solar panels, the first frame defining a recess of the first solar module and associated with the depth of the first frame;
the second frame has a depth relative to an inactive surface of the second set of solar panels, the second frame defining a recess of the second solar module and associated with the depth of the second frame; and
each of the first set of electronic circuits and the second set of electronic circuits is disposed within a volume that includes the recess of the first solar module and the recess of the second solar module.

16. The apparatus of claim 14, wherein each of the first set of electronic circuits and the second set of electronic circuits includes at least one of (a) one or more microinverters, or (b) one or more power optimizers.

17. The apparatus of claim 14, further comprising:
a substantially truncated tapered structure with an upper surface and a lower surface, the upper surface defining an opening with (1) a first portion that is angled to substantially match a slope of an inactive surface of a solar panel from the first set of solar panels, and (2) a second portion that is angled to substantially match a slope of an inactive surface of a solar panel from the second set of solar panels,
the truncated tapered structure configured to mechanically support each of the first solar module and the second solar module during use, and
the truncated tapered structure configured to nest within a further truncated tapered structure during transport.

18. The apparatus of claim 14, wherein:
the set of electronic circuits of the first solar module is disposed with a portion of the first solar module that is collocated with a hinge from the at least one hinge, and
the set of electronic circuits of the second solar module is disposed with a portion of the second solar module that is collocated with the hinge from the at least one hinge.

19. The apparatus of claim 14, further comprising:
a cross-tray member with a first end portion and a second end portion, the first end portion being mechanically coupled to the frame of the first solar module and the second end portion being mechanically coupled to the frame of the second solar module,
the cross-tray member configured to limit an upper bound of a relative angle between the first solar module and the second solar module to a predefined value.

20. The apparatus of claim 14, wherein an active surface of the first set of solar panels faces an active surface of the second set of solar panels when the apparatus is in the closed position, the apparatus further comprising an elastic member disposed between the active surface of the first set of solar panels and the second set of solar panels.

21. The apparatus of claim 14, wherein an inactive surface of the first set of solar panels faces an inactive surface of the second set of solar panels when the apparatus is in the closed position.
